(19) United States
(12) Patent Application Publication
(10) Pub. No.: US 2026/0205022 A1
(43) Pub. Date: Jul. 16, 2026

(54) THREE-PORT POWER ARCHITECTURE AND CONTROL STRATEGY

(71) Applicant: DIGIQ POWER LTD., Kingston (CA)

(72) Inventors: Yang CHEN, Hefei (CN); Sina SALEHI DOBAKHSHARI, Richmond Hill (CA); Binghui HE, Ottawa (CA); Yan-Fei LIU, Kingston (CA)

(21) Appl. No.: 19/448,520

(22) Filed: Jan. 14, 2026

Related U.S. Application Data
(60) Provisional application No. 63/745,287, filed on Jan. 14, 2025.

(51) Int. Cl. H02M 3/335; H02J 7/90; H02M 1/00; H02M 3/00

(52) U.S. Cl. CPC H02M 3/33584; H02J 7/933; H02M 1/0058; H02M 3/01; H02M 3/33592; H02J 2207/20

(57) ABSTRACT

A three-port LLC resonant converter and power conversion system bidirectionally transfers power among three ports, each operable as a source or a load. The converter comprises a primary-side switching network at a first port driving a transformer, and secondary-side resonant tanks at second and third ports, the transformer providing galvanic isolation and voltage gain. The system includes a controller configured to monitor port voltages and power and to generate gate-drive signals that regulate power flow between an input port and at least one output port via switching-frequency control. Cross-regulation allows one port to be trimmed while maintaining another substantially constant. Implementations include full-bridge and voltage-doubler rectification on the secondary side and support soft switching to reduce losses, with multi-phase transformer variants to distribute conduction and thermal stress and scale power capability.

### CROSS REFERENCE

This application claims all benefit, including priority, to U.S. provisional application No. 63/745,287, filed on Jan. 14, 2025, the contents of which are hereby incorporated by reference.

### FIELD

Embodiments of the present disclosure relate to the field of electrical circuitry, and more specifically, embodiments relate to devices, systems and methods for three-port power architecture and control.

### INTRODUCTION

Modern multi-source, multi-load power systems frequently interconnect an energy storage system, a low-voltage DC rail, and a high-voltage DC rail using a cascade of two separate DC-DC converters. DC-DC converters are limited to two ports that serve as one of an input, output, or bidirectional interface, depending on the topology and operational context.

When integrating three or more ports into a single power architecture, certain power paths necessarily traverse both DC-DC converters in series, which compounds conversion losses thereby degrading overall system efficiency.

Multi-converter solutions also duplicate fundamental subassemblies such as switching networks, resonant elements, rectification stages, and magnetic components, resulting in unnecessary component overlap, added cost, increased volume, and heightened thermal burden. Therefore, improvements in the architectures and controls of multi-source, multi-load power systems are desired.

### SUMMARY

When integrating three or more ports into a single power architecture containing two DC-DC converters, certain power paths may traverse both DC-DC converters in series, which compounds conversion losses relative to scenarios where a single stage could accommodate the transfer, thereby degrading overall system efficiency. Therefore, it may be beneficial to merge multiple converters into one and design a singular converter capable of efficiently handling multiple bidirectional loads.

A three-port LLC resonant converter is described for transferring power between three ports each acting as an input port or a load port. The converter contains a first port coupled in series to at least one winding on a primary side of a transformer and coupled to a switching network containing at least two switches Q1 and Q2 which control a current flow to the at least one primary side winding of the transformer, a second port coupled to at least one first winding on a secondary side of the transformer, and having a first resonant tank and a first rectifier between the second port and the at least one first winding on the secondary side of the transformer, a third port coupled to at least one second winding on the secondary side of the transformer, and having a second resonant tank and a second rectifier between the third port and the at least one second winding on the secondary side. Further, the proposed three-port LLC converter is configured such that one of the first, second and third ports is the input port which acts as a power source for the three-port LLC resonant converter, and at least one of the first, second and third ports is the load port which receives the power from the power source and transmits the power to a load.

In some embodiments, the switches Q1 and Q2 of the first port, at least two switches in the first rectifier of the second port, and at least two switches of the second rectifier of the third port are active switches which are configured for bi-directional operation.

In some embodiments, the first port is coupled to an energy storage device which can act as the load when the first port is the load port, and as the power source when the first port is the input port.

In some embodiments, when the energy storage device acts as the power source, the first port is configured as an input port and the second and third ports are configured as output ports, such that voltages at the second and third ports vary with a voltage at the first port.

In some embodiments, when the energy storage device acts as the load, the first port is configured as a load port and one of the second and third ports is configured as the input port, and a battery charging current is controlled by the voltage at the input port.

In some embodiments, the first rectifier at the second port is implemented as a full bridge rectifier, and the second rectifier at the third port is implemented as a voltage doubler.

In some embodiments, the second port is connected to a bidirectional DC-DC regulator and the third port is connected to a bidirectional DC-AC inverter.

In some embodiments, switches of an input port operate as control switches and switches of an output port operate as synchronous rectifiers.

In some embodiments, a resonant frequency of the first resonant tank and a resonant frequency of the second resonant tank are about equal.

In some embodiments, the transformer provides galvanic isolation between the first, second, and third ports to maintain a distinct ground reference at each of the ports.

In some embodiments, the first port comprises a battery pack operating at approximately 3 V, the second port operates between 20 V and 24 V, and the third port operates between 330 V and 360 V.

In some embodiments, comprising a multi-phase transformer topology including first and second transformers whose primary windings are connected in parallel at the first port and whose secondary and tertiary windings are connected in series at the second and third ports, respectively, wherein a first primary winding is driven by the switches Q1 and Q2 in interleaved operation, and a second primary winding is driven by switches Q3 and Q4 in interleaved operation.

An approach for control of a three port power conversion system using a controller for transferring power between three ports each acting as either a load or a source is also described. According to this embodiment, the conversion system contains a first port of the power conversion system coupled to a battery, a second port of the power conversion system coupled to a bi-directional DC-DC regulator, a third port of the power conversion system coupled to a bi-directional DC-AC inverter, a first, second, and third switching network within the power conversion system coupled to the first, second, and third port, respectively, and one of the first, second, and third ports is configured as an input port which feeds an input power into the conversion system, at least one of the first, second and third ports is configured as an output port which receives the power from the input port and transfers the power to at least one of the battery, the bi-directional DC-DC regulator and the bi-directional DC-AC inverter, a controller coupled to the first, second and third switching networks, and configured for sensing a voltage and a power level across each of the first, second, and third ports; and generating, based on the sensed voltage and power level, a first, second and third gate drive signal for the first, second and third switching networks, respectively, which control the power flowing between the input port and the at least one output port.

In some embodiments, a transformer coupled between the first, second and third switching networks electrically isolates the first, second and third ports.

In some embodiments, when the first port is configured as an input port, a voltage supplied to the third port is controlled by the bi-directional DC-AC inverter, and a voltage supplied to the second port is controlled by the bi-directional DC-DC regulator.

In some embodiments, the controller is configured to calculate a set battery charging current based on a maximum converter power and a measured power at the third port, and the generating of the gate drive signal of the switching network of an input port is based on matching an actual battery charging current to the set battery charging current.

In some embodiments, the controller is configured to supply a voltage to the first port given the set battery charging current based on the parasitic impedance of the power conversion system.

In some embodiments, the controller is configured to set a switching frequency of the power conversion system to be substantially equal to a resonant frequency of a resonant components of the power conversion system.

In some embodiments, the controller is configured to turn on one or more of the first, second, and third switching networks under a zero-voltage switching condition.

In some embodiments, the controller is further configured for adjusting the switching frequency based on the resonant frequency using feedback from the second port, and maintaining a voltage at the third port substantially constant within a predefined tolerance to regulate a voltage at the second port with cross-regulation.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is an example power system consisting of two DC-DC converters used to transfer power between a solar panel system, an energy storage system, and a high DC voltage load/source, according to some embodiments.

FIG. 1B is an example power system consisting of two DC-DC converters used to transfer power between an energy storage system, a high DC voltage load/source, and a low DC voltage load/source, according to some embodiments.

FIG. 1C is a three-port converter system configured for bidirectional power transfer at each port, according to some embodiments.

FIGS. 2A-2G are power flow diagrams of the three port converter according to Mode 1: From Port 1 to Port 2 (FIG. 2A); Mode 2: From Port 2 to Port 1 (FIG. 2B); Mode 3: From Port 1 to Port 3 (FIG. 2C); Mode 4: From Port 3 to Port 1 (FIG. 2D); Mode 5: From Port 1 to Port 2 and Port 3 (FIG. 2E); Mode 6: From Port 3 to Port 1 and Port 2 (FIG. 2F); and Mode 7: From Port 2 to Port 1 and Port 3 (FIG. 2G), according to some embodiments.

FIG. 3 is a three-port converter system configured for bidirectional power transfer between an energy storage system, a high DC voltage load/source, and a low DC voltage load/source, according to some embodiments.

FIG. 4 is a three-port converter configured for voltage isolation among the ports using a transformer, according to some embodiments.

FIG. 5 is an LLC resonant converter comprising a switching network, a resonant tank, a center tapped transformer, and a rectifier, according to some embodiments.

FIG. 6 is an example three-port push-pull LLC converter composed of two resonant tanks, according to some embodiments.

FIG. 7A is an example three-port push-pull LLC converter in which a voltage doubler rectifier is used at Port 3, and a full-bridge rectifier with unity voltage gain is used at Port 2, according to some embodiments.

FIG. 7B is an example three-port full-bridge LLC converter in which a voltage doubler rectifier is used at Port 3, and a full-bridge rectifier with unity voltage gain is used at Port 2, according to some embodiments.

FIG. 8 is an example LLC resonant converter having a voltage doubler rectifier with a resonant capacitor split in two and replaced with the rectifier's capacitors, according to some embodiments.

FIG. 9A is a three-port converter system containing a 2-phase transformer topology, according to some embodiments.

FIG. 9B is an n-phase transformer system comprising multiple transformers, according to some embodiments.

FIG. 9C is a three-port converter system with a 2-phase transformer topology, where each primary winding is connected to an individual set of switches, according to some embodiments.

FIG. 9D is a three-port converter system with a multi-phase transformer topology, where each primary winding is connected to an individual set of switches, according to some embodiments.

FIG. 10 is a power management and voltage regulation diagram for a three-port converter as shown in FIG. 8, according to some embodiments.

FIG. 11A is an equivalent circuit of the three-port converter circuit as shown in FIG. 10, according to some embodiments.

FIG. 11B is an equivalent circuit of the three-port converter circuit as shown in FIG. 10, using a first harmonic approximation, according to some embodiments.

FIG. 12A is an equivalent circuit of a three-port converter circuit for operation in Mode 1 as shown in FIG. 2A, according to some embodiments.

FIG. 12B is a graphical representation of the voltage for Port 2 of a three port converter at various power levels versus switching frequency (Fs), according to some embodiments.

FIG. 12C is the simulation results for power transfer from Vdc1 to Vdc2 at 250 W, according to some embodiments.

FIG. 12D is the simulation results for power transfer from Vdc1 to Vdc2 at 25 W, according to some embodiments.

FIG. 13A is an equivalent circuit of a three-port converter circuit for operation in Mode 2 as shown in FIG. 2B, according to some embodiments.

FIG. 13B is a graphical representation of the voltage for Port 1 of a three port converter at various power levels versus switching frequency (Fs), according to some embodiments.

FIG. 13C is the simulation results for power transfer from Vdc2 to Vdc1 at 250 W, according to some embodiments.

FIG. 13D is the simulation results for power transfer from Vdc2 to Vdc1 at 25 W, according to some embodiments.

FIG. 14A is an equivalent circuit of a three-port converter circuit for operation in Mode 3 as shown in FIG. 2C, according to some embodiments.

FIG. 14B is a graphical representation of the voltage for Port 3 of a three port converter at various power levels versus a switching frequency (Fs), according to some embodiments.

FIG. 14C is the simulation results for power transfer from Vdc1 to Vdc3 at 300 W, according to some embodiments.

FIG. 14D is the simulation results for power transfer from Vdc1 to Vdc3 at 30 W, according to some embodiments.

FIG. 15A is an equivalent circuit of a three-port converter circuit for operation in Mode 4 as shown in FIG. 2D, according to some embodiments.

FIG. 15B is a graphical representation of the voltage for Port 1 of a three port converter at various power levels versus switching frequency (Fs), according to some embodiments.

FIG. 15C is the simulation results for power transfer from Vdc3 to Vdc1 at 300 W, according to some embodiments.

FIG. 15D is the simulation results for power transfer from Vdc3 to Vdc1 at 30 W, according to some embodiments.

FIG. 16A is an equivalent circuit of a three-port converter circuit for operation in Mode 5 shown in FIG. 2E, according to some embodiments.

FIG. 16B is a graphical representation of the voltage for Ports 2 and 3 of a three port converter at various power levels versus switching frequency (Fs), according to some embodiments.

FIG. 16C is the simulation results for power transfer from Vdc1 to Vdc2 at 250 W and to Vdc3 at 50 W, according to some embodiments.

FIG. 16D is the simulation results for power transfer from Vdc1 to Vdc2 at 25 W and to Vdc3 at 275 W, according to some embodiments.

FIG. 17A is an equivalent circuit of a three-port converter circuit for operation in Mode 7 as shown in FIG. 2G, according to some embodiments.

FIG. 17B is a simplified equivalent circuit of a three-port converter circuit for operation in Mode 7 as shown in FIG. 2G, according to some embodiments.

FIG. 17C is a graphical representation of the voltage for Ports 1 and 2 of a three port converter at various power levels versus switching frequency (Fs), according to some embodiments.

FIG. 17D is the simulation results for power transfer from Vdc3 to Vdc1 at 50 W and to Vdc2 at 250 W, according to some embodiments.

FIG. 17E is the simulation results for power transfer from Vdc3 to Vdc1 at 275 W and to Vdc2 at 25 W, according to some embodiments.

FIG. 18A is an equivalent circuit of a three-port converter for operation in Mode 7 as shown in FIG. 2G, according to some embodiments.

FIG. 18B is a graphical representation of the voltage for Ports 1 and 3 of a three port converter at various power levels versus switching frequency (Fs), according to some embodiments.

FIG. 18C is the simulation results for power transfer from Vdc2 to Vdc1 at 25 W and to Vdc3 at 225 W, according to some embodiments.

FIG. 18D is the simulation results for power transfer from Vdc2 to Vdc1 at 225 W and to Vdc3 at 25 W, according to some embodiments.

FIG. 19 is a three-port converter system with three-port resonant converter, battery, bidirectional DC-DC regulator connected to electronic load and solar cell, and bidirectional DC-DC inverter (rectifier) connected to AC voltage, according to some embodiments.

### DETAILED DESCRIPTION

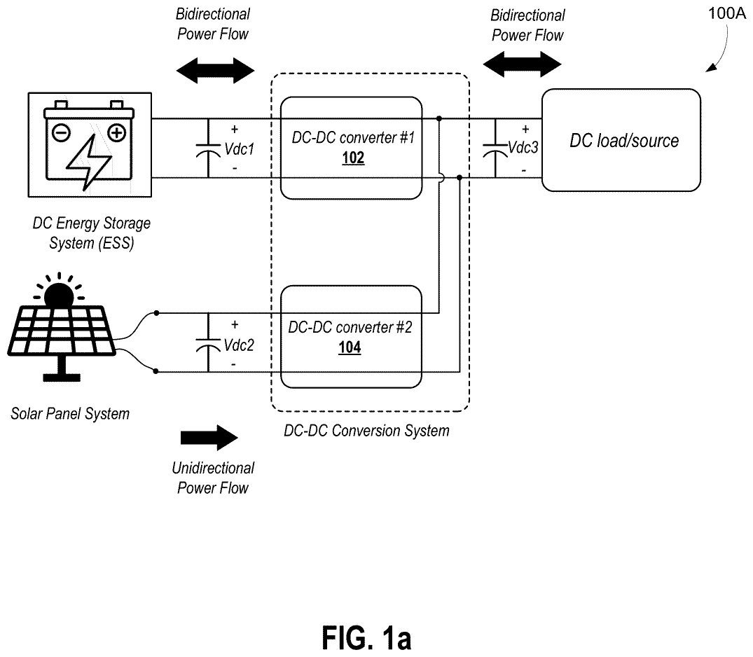

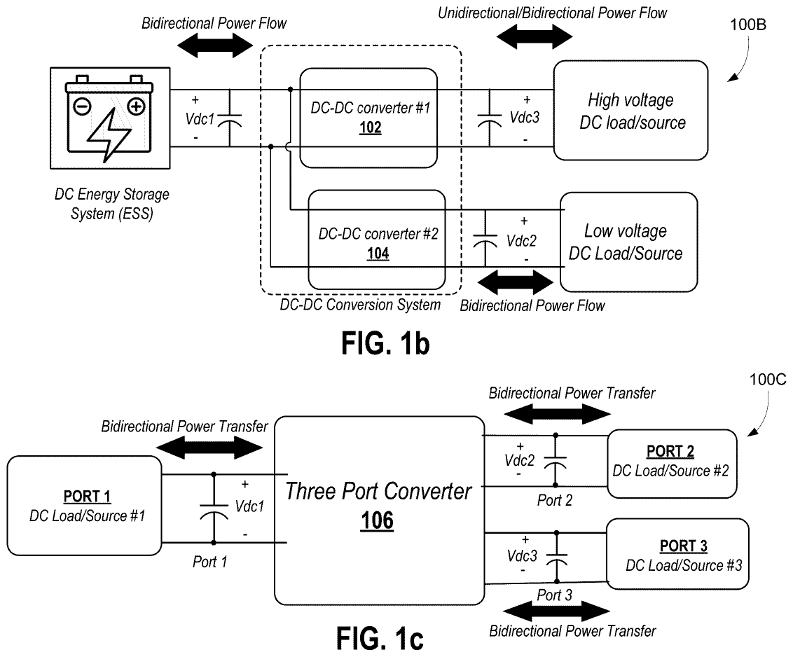

In FIG. 1A, an example multi-load multi-source power system 100A is shown in which two DC-DC converters 102 and 104 connect each port, according to some embodiments. As seen in system 100A, DC-DC converters may have two ports, where the two ports can be an input port and output port, or two bidirectional ports. For system 100A, converter 102 is a bidirectional converter, having two bidirectional ports that can transfer power in both directions between Vdc1 and Vdc2. DC-DC converter 104 is a unidirectional converter, having an input port and an output port, that is only able to transfer power from Vdc2 to Vdc3.

In the example provided in system 100A, converters 102 and 104 are used to transfer power between a solar panel system (Vdc2), an energy storage system (Vdc1) and a high DC voltage load/source (Vdc3). In this example, system 100A may harvest power from the solar panel (Vdc2) and transmit the power through converter 104 to the DC load (Vdc3). If the harvested power from the solar panel is more than the demanded power from the DC load, system 100A may transmit through both converters 102 and 104 the excessive power for storage to the energy storage system (ESS). If the demanded power from the DC load is higher than the available power from the solar panel, the ESS may compensate for the power shortage and transmit through converter 102 additional power to the DC load. Lastly, if the DC load is replaced with a DC source (for example a grid-tied inverter operating as a rectifier), it can transmit power through converter 102 to charge the ESS (i.e., converter 102 is bi-directional).

Variants of system 100A are possible. FIG. 1B shows an example power system 100B consisting of two DC-DC converters used to transfer power between an energy storage system (Vdc1), a high DC voltage load/source (Vdc3), and a low DC voltage load/source (Vdc2), according to some embodiments. In system 100B, the solar panel at Vdc2 in system 100A is replaced with a low voltage DC load/source. Further, converters 102 and 104 are both connected to the terminals of Vdc1 (rather than the terminals of Vdc3 in system 100A). Due to replacing the solar panel at Vdc2 with a low voltage DC load/source, both Vdc3 and Vdc2 can now operate as either a load or a source for system 100B. Therefore, both converters 102 and 104 in system 100B are bidirectional such that all three ports (i.e., Vdc1, Vdc2, Vdc3) are capable of transferring power to, and receiving power from, one another.

Power loss may occur within both system 100A and system 100B when power passes through either of the two DC-DC converters 102 and 104. Therefore, in certain situations, such as in system 100A when power is transferred from Vdc2 (solar panel) to Vdc1 (ESS), or in system 100B when power is transferred from Vdc2 (low voltage DC load/source) to Vdc3 (high voltage DC load/source), current must pass through both converters 102 and 104, resulting in unnecessary converter power loss compared to if the current only had to pass through a single DC-DC converter. However, as DC-DC converters 102 and 104 are limited to two ports (i.e., input and output; or bidirectional), at least two DC-DC converters are required to handle power architectures having three loads/sources, resulting in increased power losses which impact the efficiency of the system.

Further, as both of the DC-DC converters 102 and 104 in systems 100A and 100B are performing the same core function (i.e., voltage regulation), this architecture introduces unnecessary component overlap as both DC-DC converters 102 and 104 may have a distinct rectifier, switching network, resonant tank and transformer. Therefore, systems 100A and 100B may have unnecessary component costs resulting from overlapping components within each of the two DC-DC converters.

Therefore, a technical problem exists with systems 100A and 100B due to the unnecessarily high power loss and component costs resulting from having two distinct DC-DC converters for power transfer between three loads/sources. FIG. 1C shows a three-port converter system 100C configured for bidirectional power transfer at each port, according to some embodiments. The proposed system 100C merges the converters 102 and 104 from systems 100A and 100B into a single three-port converter 106. By implementing a three-port converter 106 within system 100C, the three loads/sources (DC load/source #1, #2, #3) can achieve power transfer amongst one another while minimizing the component cost and power losses compared to systems 100A and 100B. For example, in system 100C, regardless of the direction of power transfer (i.e., from DC load/source #1 to #2, from DC load/source #3 to #2, etc.) the current within system 100C will only pass through a single converter architecture. Therefore, unlike systems 100A and 100B, there are no operating conditions where converter power losses will be doubled due to the current passing through two distinct DC-DC converters. Further, by merging the two distinct DC-DC converters 102, 104 used in systems 100A and 100B into a single three-port DC-DC converter 106, system 100C may reduce the total component costs for the architecture by sharing resonant, rectifier, magnetic and switching components.

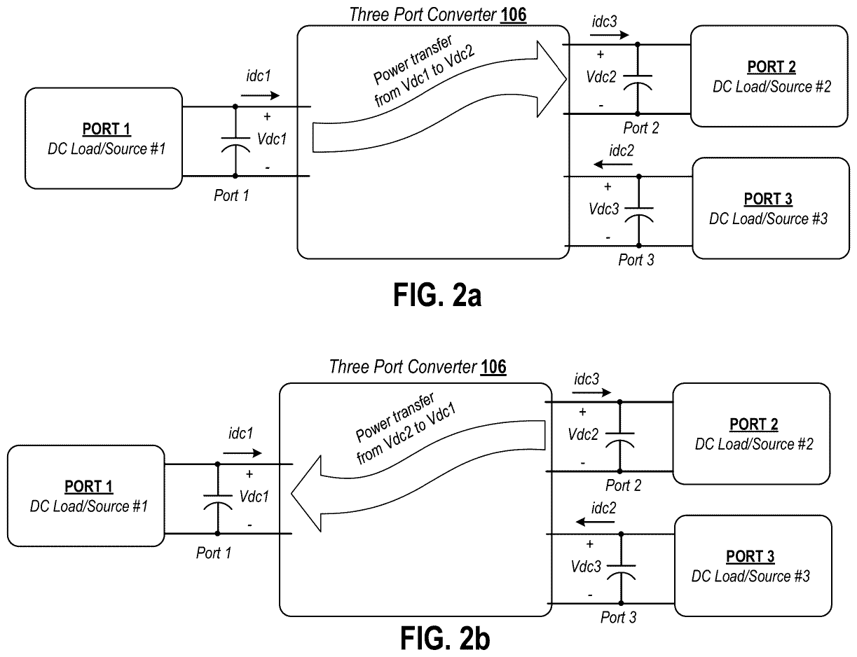

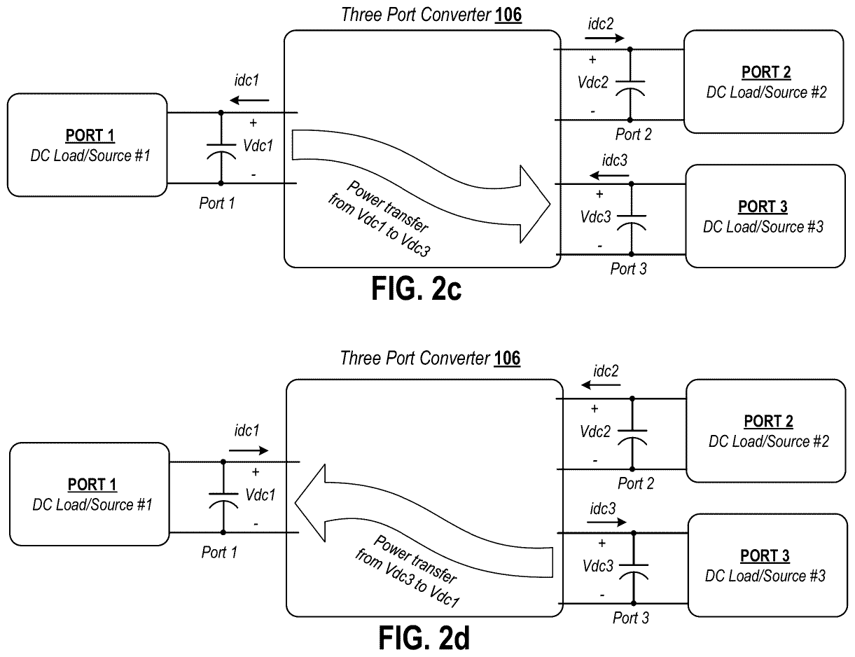

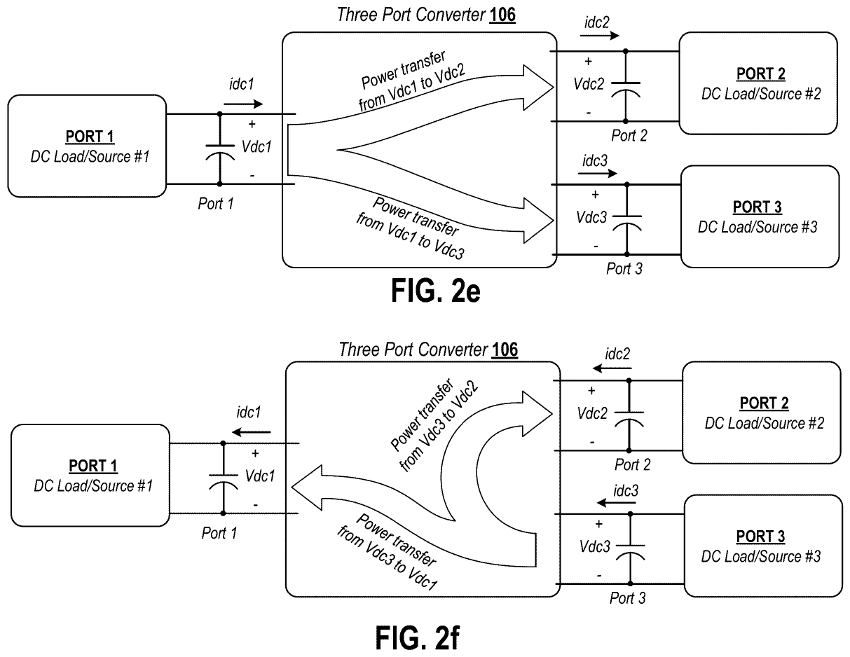

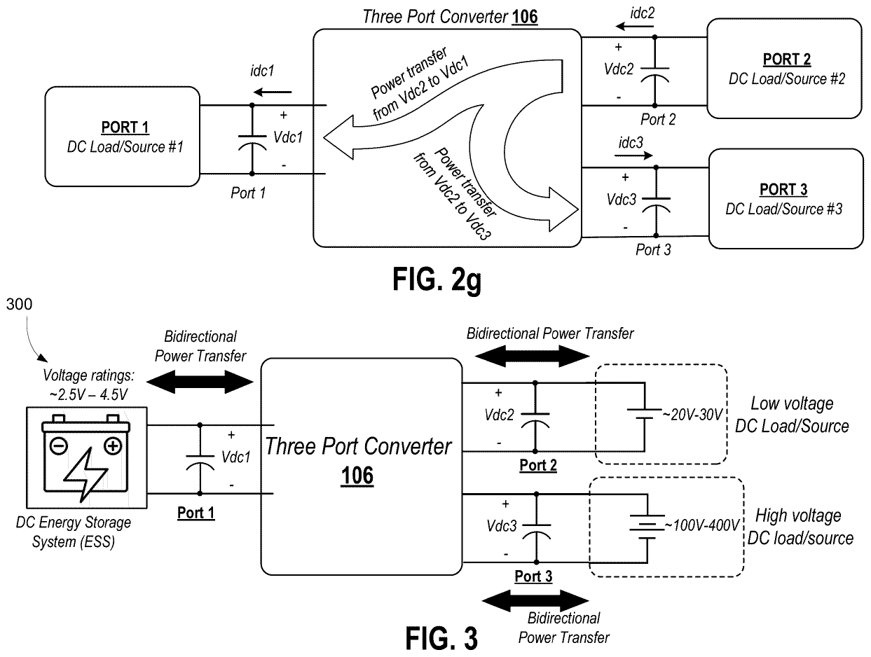

Proposed herein are embodiments of a three-port converter with three bidirectional ports. System 100C in FIG. 1C is a possible embodiment of the three-port DC-DC converter 106 in which all the three ports are bidirectional. However, in other embodiments, the three ports can be any combination of an input port, output port and bidirectional port. Accordingly, in system 100C, the possible power flow modes among the ports can be considered as shown by the embodiments as illustrated in FIG. 2A-FIG. 2G, as:
FIG. 2A: Mode 1: From Port 1 to Port 2.
FIG. 2B: Mode 2: From Port 2 to Port 1.
FIG. 2C: Mode 3: From Port 1 to Port 3.
FIG. 2D: Mode 4: From Port 3 to Port 1.
FIG. 2E: Mode 5: From Port 1 to Port 2 and Port 3.
FIG. 2F: Mode 6: From Port 3 to Port 1 and Port 2.
FIG. 2G: Mode 7: From Port 2 to Port 1 and Port 3.

Depending on the operational setting which the proposed three-port converter 106, is applied to, there may be certain technical requirements which are necessary for the proposed converter 106 to provide an improvement in performance and efficiency. For example, some embodiments of converter 106 may operate bidirectionally such that power can be transferred to each port in both directions.

In some embodiments, such as in system 300 discussed below, converter 106 may have a high voltage gain in order to effectively regulate voltage between multiple sources/loads within different voltage levels. For example, Vdc3 can be a grid-tied inverter (i.e., a high voltage DC load/source), such that if the grid voltage is 110 VAC, the minimum value of Vdc2 would be 155 VDC, and if the grid voltage is 220 VAC, the minimum value of Vdc2 would be 310 VDC. However, Vdc2 may be a small charger or portable battery pack, which represents a low voltage DC load/source having a voltage between 20 VDC and 30 VDC, thereby requiring a high voltage gain in order to perform power transfer with Vdc3 (i.e., high voltage DC load/source). Further, Vdc1 may be an ESS consisting of a battery cell with a voltage between about 2 VDC and 4 VDC. In some embodiments, ESS may be formed by multiple battery cells connected in series and/or parallel. When connecting battery cells in series, the voltage across the terminals of Vdc1 can be increased, however, this may cause issues with charge/discharge balance among the battery cells. Therefore, it may be beneficial to connect the battery cells in parallel to eliminate the charge/discharge balance issue. Since the voltage of each battery cell is typically between 2 VDC to 4 VDC, the voltage presented at the terminals of Vdc1 when the battery cells are connected in parallel will be about 2 Vdc to 4 Vdc.

FIG. 3 shows a three-port converter system 300 configured for bidirectional power transfer between an ESS, a high DC voltage load/source, and a low DC voltage load/source, according to some embodiments. As a variant of system 100C, system 300 comprises of a three-port converter 106 connected to three DC loads/sources (collectively the “Ports”) with the approximate voltage rating for the Ports indicated. In system 300, converter 106 has a Port 1 (Vdc1=2−4 Vdc) consisting of an ESS, a Port 2 (Vdc2=20 Vdc−30 Vdc) consisting of a low voltage DC load/source, and a Port 3 (Vdc3=100 Vdc−400 Vdc) consisting of a high DC load/source. Based on the indicated voltage ratings in FIG. 3, when the converter 106 transfers power from Port 1 to Port 3, the voltage must be stepped up around 100 to 200 times. In addition, the converter 106 may have to step down the voltage almost 100 to 200 times when it is transferring power from Port 3 to Port 1.

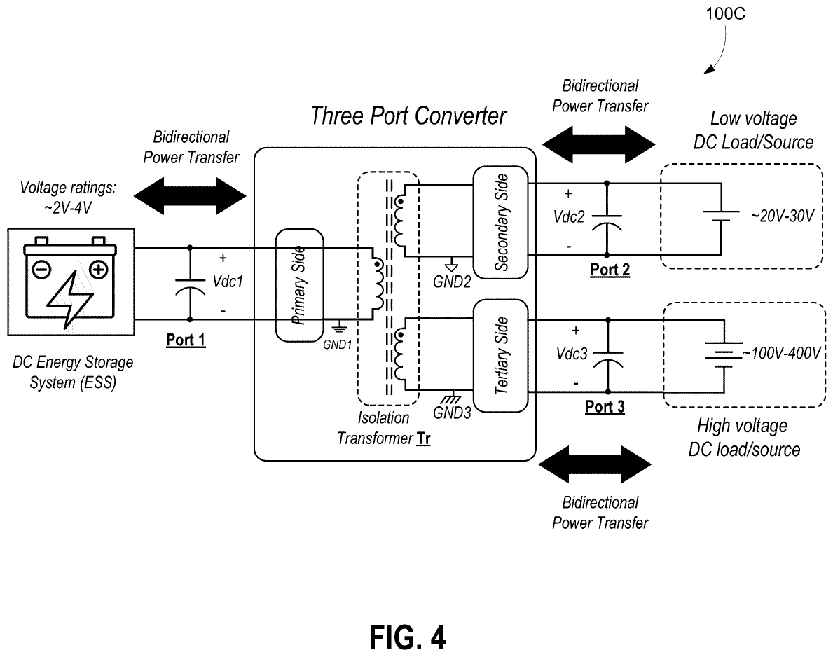

In some embodiments, converter 106 may be configured to isolate the voltage from each of the Ports, such as when one of the Ports are connected to an AC grid (i.e., High voltage DC load/source at Vdc3). For example, in FIG. 4, an embodiment of system 100C is shown in which converter 106 is configured for voltage isolation among the ports using a transformer. Due to the voltage isolation of the transformer, each of the Ports has a distinct ground connection which are indicated in FIG. 4 as GND1, GND2, and GND3. Maintaining electrical isolation between the ports may be desirable for user and system safety when one port operates at high voltage, such as where Port 3 is tied to an AC grid via an inverter. By galvanically isolating the Ports, converter 106 may mitigate safety risks from high-voltage inputs that could otherwise propagate to low-voltage domains and pose a hazard.

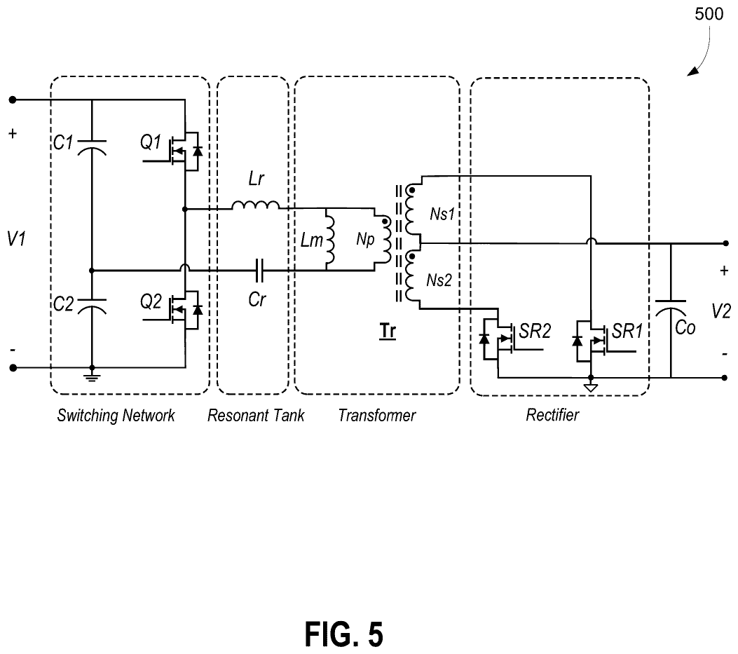

FIG. 5 shows an exemplary LLC resonant converter 500 comprising a switching network with two switches Q1 and Q2 configured as a half-bridge switching network, a resonant tank consisting of a resonant inductor (Lr) and a resonant capacitor (Cr), a center tapped transformer (Tr) containing three windings (i.e., primary windings is indicated as Np, secondary windings is indicated as Ns1 or Ns2), and a magnetizing inductance shown as Lm, and a rectifier consisting of two synchronous rectifiers (SR1 and SR2), according to some embodiments.

The configuration of the LLC resonant converter 500 is purely exemplary, and each part of the LLC resonant converter 500 (switching network, resonant tank, transformer windings, and rectifier) can be modified based on the desired performance.

A technical benefit of LLC resonant converter 500 is that it can operate bidirectionally. In FIG. 5, when the primary switches (Q1 and Q2) within the switching network operate as main switches, and the secondary switches (SR1 and SR2) in the rectifier operate as synchronous rectifier, the converter 500 transfers power from V1 to V2. However, if the secondary switches (SR1 and SR2) in the rectifier operate as main switches, and the primary switches (Q1 and Q2) in the switching network operate as synchronous rectifier, the converter 500 transfers power from V2 to V1. Therefore, when the converter 500 transfers power from V2 to V1, it operates as a push-pull resonant converter.

The transformer Tr not only provides voltage isolation in converter 500 but also achieves the desired voltage gain by implementing the proper turn ratio between the primary (Np) and secondary windings (Ns1, NS2).

When converter 500 is connected between a high voltage load/source and low voltage load/source, the high voltage side of converter 500 will have a lower current value, and the low voltage side of converter 500 will have a higher current value. To improve efficiency within converter 500, the minimum number of components should be exposed to the higher current present on the low voltage side. For example, V1 may be connected to the high voltage side and V2 may be connected to the low voltage side, so that the resonant tank and switching network are exposed to the lower current (on the high voltage side) in comparison to the rectifier on the low voltage side. As the switching network and resonant tank contain six components (Lr, Cr, Q1, Q2, C1, C2), while the rectifier contains only 3 components (SR1, SR2, Co), the higher current from the terminal at V2 on the low voltage side is exposed to the minimum number of components to reduce power losses within converter 500. An additional technical advantage of using V1 as the high voltage side and V2 as the low voltage side is that the half-bridge switching network containing Q1 and Q2 may operate as a voltage doubler when transferring power from V2 to V1. Therefore, the voltage gain required from the turn ratio of the transformer Tr is halved, which reduces the cost and complexity of transformer Tr required to achieve the required voltage regulation.

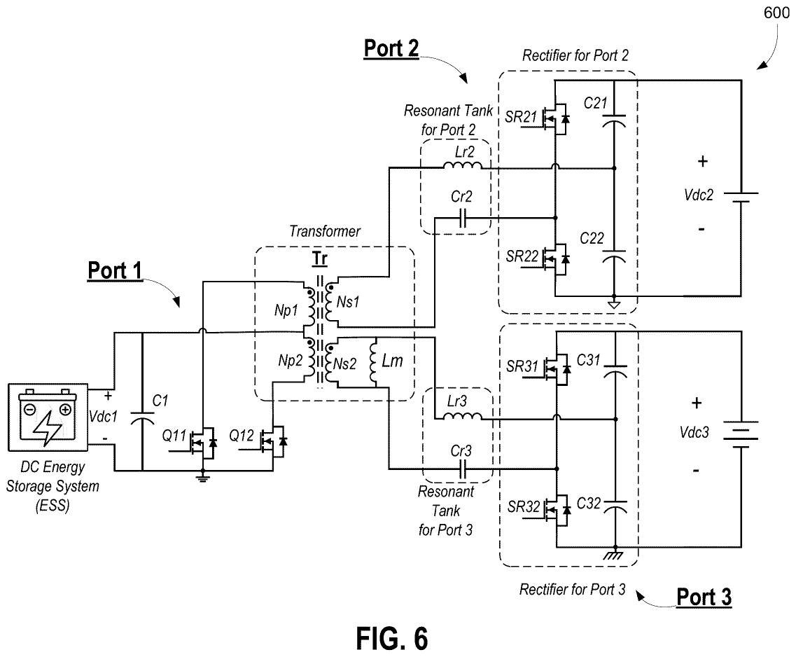

In FIG. 6, a system 600 is shown which has an embodiment of a proposed three-port converter 106 connected to an ESS at Port 1 (Vdc1), and two DC load/sources at Ports 2 and 3 (Vdc2, Vdc3), according to some embodiments. In system 600, converter 106 is composed of a transformer Tr which has four windings (two primary windings Np1, Np2, one secondary winding Ns1, and one tertiary winding Ns2). For Port 1 (i.e., Vdc1), an ESS is connected as a push-pull configuration with switches Q11, Q12 and center-tapped primary windings Np1, Np2 of the transformer Tr. A switching network containing switches Q11 and Q12 is coupled to the transformer Tr, such that switch Q11 is coupled in series with primary winding Np1 and switch Q12 is coupled in series with primary winding Np2. Compared to systems 100A and 100B, three-port converter 106 contains a single transformer Tr which merges the two transformers present in the two DC-DC converter topologies. Further, system 600 contains only one switching network (i.e., Q11 and Q12 at Port 1) compared to the two switching networks which would be present in the two DC-DC converter topologies of systems 100A and 100B. The equivalent magnetizing inductance Lm of the transformer Tr is placed at the tertiary winding Ns2 on the Port 3 (Vdc3) side.

The system 600 shown in FIG. 6 is configured as a three-port push-pull LLC resonant converter, which has two secondary side outputs, Vdc2 and Vdc3. In this topology, the push-pull configuration on the primary side of transformer Tr has switches Q11, Q12, and transformer primary windings Np1, Np2 (where Np1=Np2) which are connected to the ESS battery.

The transformer Tr in system 600 has four windings (two primary windings Np1, Np2, one secondary winding Ns1, and one tertiary winding, Ns3). The equivalent magnetizing inductance Lm of the transformer Tr is placed at the tertiary winding connected to Port 3, however, this is solely for the purpose of simplifying the simulations discussed below. The magnetizing inductance Lm can be placed at any of the windings of transformer Tr.

The secondary winding Ns1, resonant tank Lr2, Cr2 and full bridge rectifier consisting of synchronous rectifiers SR21, SR22, SR23, and SR24 are coupled to Port 2, and handle the input and output from Vdc2.

The tertiary winding Ns2, resonant tank Lr3, Cr3 and voltage doubler circuit composed of synchronous rectifiers SR31, SR32 and capacitors C31, C32 are coupled to Port 2, and handle the input and output from Vdc3.

As can be seen in system 600, converter 106 contains two resonant tanks. The first resonant tank is coupled to Port 2 and consists of Lr2, Cr2, and the second resonant tank is coupled to Port 3 and consists of Lr3 and Cr3. In a preferred embodiment, the resonant frequencies of these two resonant tanks are the same. For example, in the converter 106 of system 600, and as shown in Table I, Lr2=6 uH, Cr2=187 nF and Lr3=33 uH and Cr3=34 nF. The resonant frequency Fr2=1/(2*3.14*sqrt (Lr2*Cr2)=150 kHz and Fr3=1/(2*3.14*sqrt (Lr3*Cr3)=150 kHz. These resonant tank specifications are preferred when the direction of power primarily flows from Vdc1 to Vdc2 and Vdc3. In other words, Vdc1 is connected to an ESS battery which is discharging, and Vdc2 and Vdc3 are consuming the power from the ESS battery.

Notably, the characteristics mentioned above relating to push-pull LLC three-phase converters also apply to full-bridge LLC three-port resonant converters.

Converter 106 may operate bidirectionally as all of the Ports are bidirectional. Further, converter 106 may leverage the combination of the turn ratio of transformer Tr and the rectifiers present at Port 2 (Vdc2) and Port 3 (Vdc3), which are configured as voltage multipliers, to achieve a high voltage gain. The transformer Tr also provides voltage isolation between all of the Ports, which enables safe operation of converter 106 when one of the Ports, such as Vdc3, is connected to an AC grid through a grid-tied inverter (i.e., a high DC load/source). Lastly, compared to a two DC-DC converter system such as that seen in systems 100A and 100B, which may implement two separate configurations of converter 500, system 600 merges overlapping components (such as transformer Tr, and switches Q11 and Q12 at Port 1) to reduce the component count and power losses.

In some embodiments, variants of the rectifier circuits at Ports 2 and 3 may be used based on the expected load differences between Vdc1, Vdc2 and Vdc3 of the three-port converter 106.

For example, according to converter 106 shown in system 600, the voltage gain from Vdc2 to Vdc1 (M21) is:

$$M 21 = \frac{Vdc 2}{Vdc 1} = N 21 \times M res 2 \times Mrec 2 \qquad ( 1 )$$

where N21 is the turn ratio between the secondary windings Ns1 and the first primary windings Np1, Np2 (i.e., N21=Ns1/Np1), Mres2 is the voltage gain of the resonant tank for Port 2, and Mrec2 is the rectifier voltage gain of the rectifier at Port 2. It is noted that Np1=Np2.

In the same way, the voltage gain from Vdc3 to Vdc1 (M31) is:

$$M 31 = \frac{Vdc 3}{Vdc 1} = N 31 \times M res 3 \times Mrec 3 \qquad ( 2 )$$

where N31 is the turn ratio between tertiary winding Ns2 and primary winding Np1, Np2 (N31=Ns2/Np1), Mres3 is the voltage gain of the resonant tank at Port 3, and Mrec3 is the rectifier voltage gain of the rectifier at Port 3.

Considering equations (1) and (2), the voltage gain from Vdc3 to Vdc2 (M32) is:

$$M 32 = \frac{Vdc 3}{Vdc 2} = \frac{N 31 \times Mres 3 \times Mres 3}{N 21 \times Mres 2 \times Mrec 2} = N 32 \frac{Mres 3 \times Mrec 3}{Mres 2 \times Mrec 2} \qquad ( 3 )$$

where N32 is the turn ratio between the tertiary winding Ns2 and the secondary winding Ns1 (N32=N3/N2).

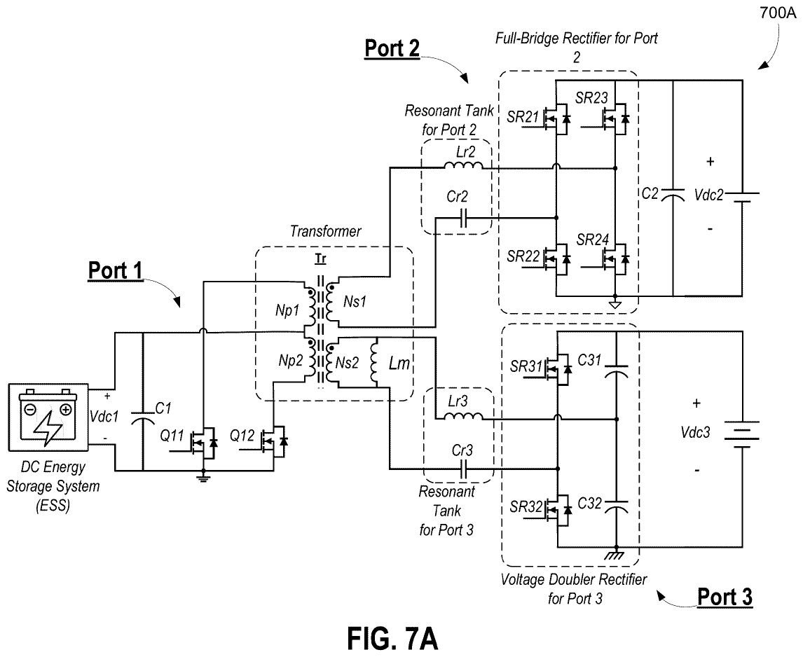

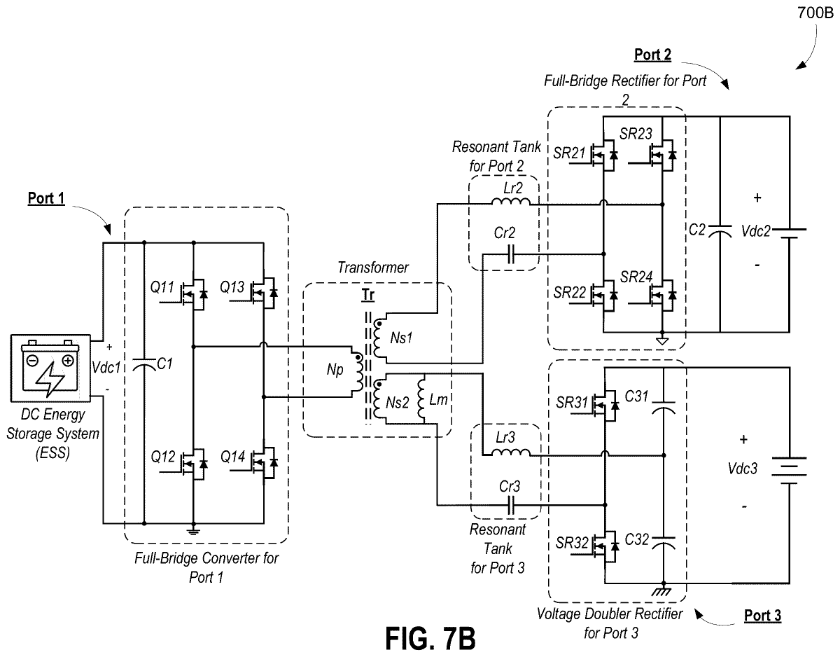

Therefore, according to equation (3), if the same voltage multiplier rectifier is being used at Port 2 and Port 3, the voltage gain from one rectifier (i.e., at Port 2) will be cancelled out by the other rectifier (i.e., at Port 3). Also, in certain embodiments of converter 106, there may be large differences between the voltage level at each of the Ports (i.e., low DC load/source at port 2 and high DC load/source at port 3). Therefore, in certain embodiments where M32 would be very high (around 10 to 20), it may be desirable to use a voltage multiplier rectifier at Port 3, and a simple voltage rectifier with a unity voltage gain at Port 2. For example, in FIG. 7A, a system 700A is shown in which the proposed three-port converter has a voltage doubler rectifier at Port 3 (i.e., at Vdc3), and a full-bridge rectifier with unity voltage gain at Port 2 (i.e., at Vdc2), according to some embodiments. The transformer Tr and voltage doubler circuit for Port 3 may be used to step-up the input from Port 1 and generate a higher DC voltage, such as 350 VDC. Considering that the ESS battery voltage (Vdc1) could be as low as about 3V, a higher voltage gain may be required between Port 1 and Port 3, therefore, the voltage doubler circuit at Port 3 may halve the number of turns required for tertiary winding Ns2 of transformer Tr.

In some embodiments, the voltage doubler at Port 3 may have two high voltage switches (instead of four), which can reduce overall component costs.

System 700B in FIG. 7B shows a three-port full-bridge (FB) LLC resonant converter, according to some embodiments. The Full-Bridge configuration containing switches Q11, Q12, Q13, Q14 is connected to the ESS battery at Port 1 and the secondary sides of Transformer Tr are the same as those shown in FIG. 7A.

The three-port push-pull LLC resonant converter (shown in FIG. 7A) and three-port Full-Bridge LLC converter (shown in FIG. 7B) may both operate bi-directionally such that the converter can transfer power between all of the Ports. As non-limiting examples, the converter can transfer power from port 1 (battery) to port 2 (Vdc2) and port 3 (Vdc3), or from port 2 (Vdc2) to port 1 (Vdc1) and port 3 (Vdc3), or from port 3 (Vdc3) to port 1 (Vdc1) and port 2 (Vdc2).

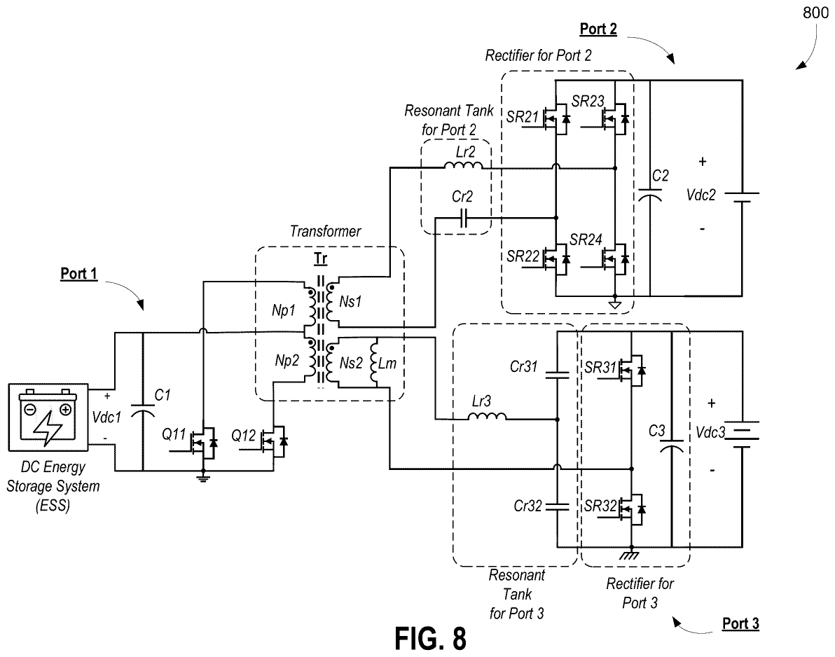

In embodiments utilizing a voltage doubler rectifier, such as Port 3 in system 700A and 700B, the resonant capacitor Cr3 can be split into two and be replaced with the rectifier's capacitors Cr31, Cr32 as shown in system 800 of FIG. 8. Comparing the three-port converter 106 in system 800 with system 700, the resonant capacitor Cr3 is split into Cr31 and Cr32 which replace the rectifier's capacitors C31 and C32. As long as the split resonant capacitors value is half of the original resonant capacitor (Cr31=Cr32=Cr3/2), the performance of the converter 106 remains the same as before while the size of converter 106 may be reduced.

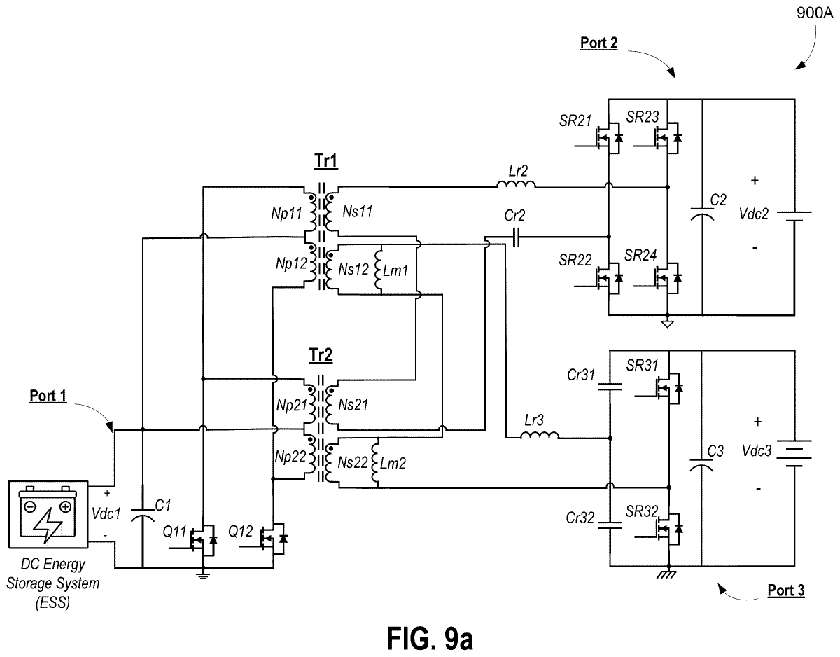

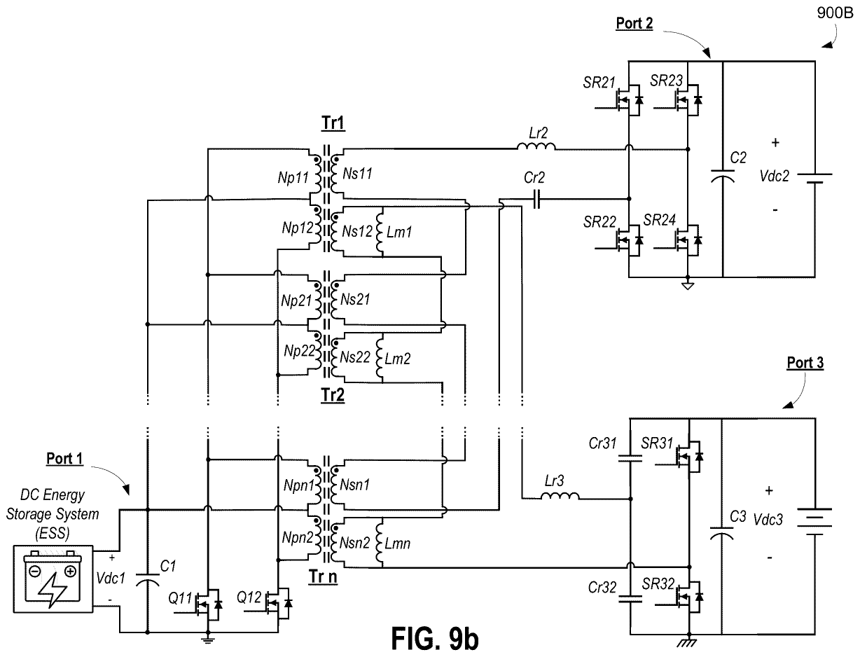

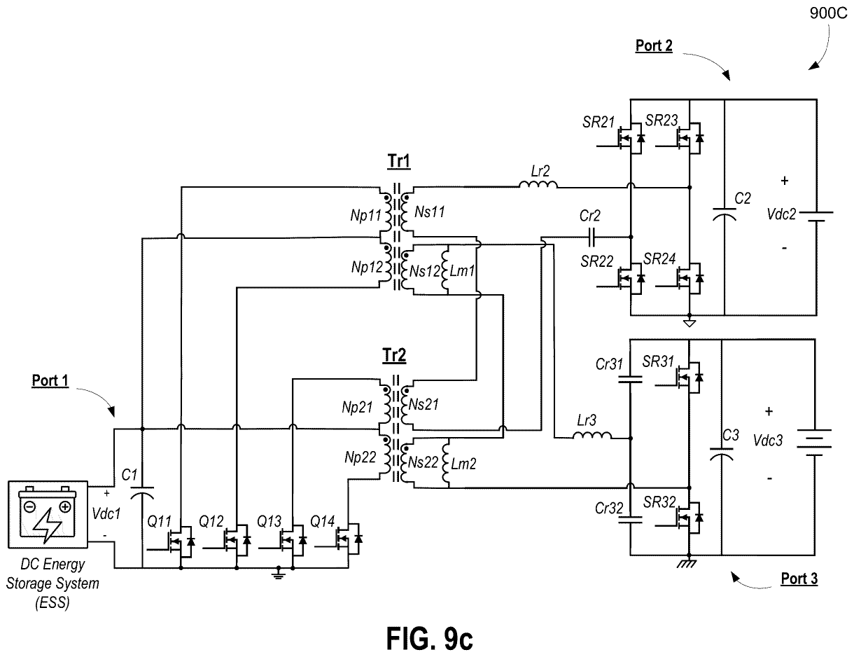

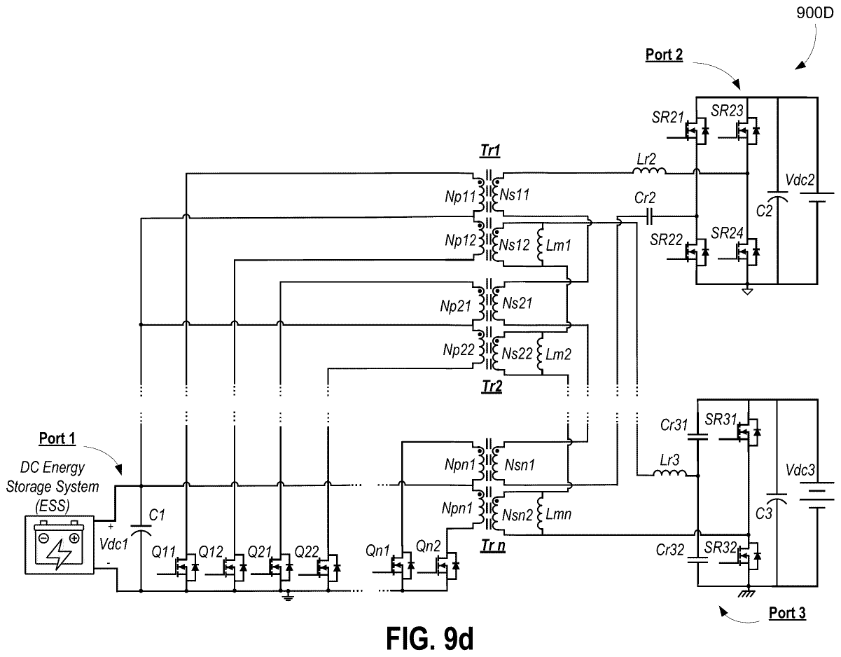

In alternative approaches using DC-DC converters, the transformer Tr may be the element which handles the full power of the circuit, resulting in bulky transformers operating with large power losses. In some embodiments of the three-port converter 106, a multi-phase transformer topology can be implemented to reduce the total conduction loss and distribute the remaining loss between two or more transformers for better thermal management and higher reliability. FIG. 9A shows a system 900a with a three-port converter 106 containing a 2-phase transformer topology (Tr1, Tr2), according to some embodiments. Specifically, each of the transformers Tr1 and Tr2 has its own set of primary windings (Np11, Np12, Np21, Np22) and secondary windings (Ns11, Ns12, Ns21, Ns22) and are connected in parallel on the primary side (i.e., at Port 1) and connected in series on the secondary (i.e., at Port 2) and tertiary sides (i.e., at Port 3). The multiple power transfer paths operate in an interleaved manner to share the load and improve performance. The transformers Tr1 and Tr2 are driven by separate switching devices (i.e., Q11 and Q12) on the primary side (i.e., at Port 1), allowing the converter 106 to split the input current across two distinct phases. By doing so, system 900a may reduce the current stress on individual components and automatically distribute power more evenly.

Embodiments of the multi-phase topology in system 900A are configured to automatically balance power among the phases equally, thus minimizing the voltage/current stress and power loss. Since the secondary windings Ns21 and Ns11 are connected in series, the secondary windings of transformers Tr1 and Tr2 will always have the same current. Similarly, as the tertiary windings Ns22 and Ns12 are connected in series, the tertiary windings of transformers Tr1 and Tr2 will always have the same current. Thus, as the secondary and tertiary windings of the transformers have the same current, the primary windings Np11, Np12, Np21, Np22 will also have the same current. Moreover, because of the parallel connection of the primary windings (i.e., Np11 and Np12 are in parallel when switch Q11 is in the on-state; and Np21 and Np22 are in parallel when Q12 is in the on-state), they will always have the same voltage. Consequently, the primary windings of the transformers Tr1 and Tr2 have the same voltage and current, which leads to equal power sharing between the transformers.

In a further variation of system 900A, FIG. 9B shows an n-phase transformer system 900B comprising multiple transformers Tr1 to Trn, according to some embodiments. Specifically, the primary windings Np11-Npn2 of all transformers Tr1, Tr2, Trn are connected in parallel, and the secondary windings Ns11, Ns21, Nsn1 and tertiary windings Ns12, Ns22, Nsn2 are connected in series, and all primary windings are being driven with one set of switches Q11, Q12. Increasing the number of transformers may provide additional phases for ripple cancellation, better current sharing, and improved thermal distribution, which reduces stress on individual components and enhances reliability. System 900B also allows the converter 106 to handle higher power levels without oversizing individual magnetic or semiconductor devices, making it ideal for high-power applications such as large energy storage systems.

In order to reduce the current stress on the switches Q11, Q12, in some embodiments, a separate set of switches can be assigned to each primary winding. FIG. 9C shows a system 900C for a three-port converter 106 containing a 2-phase transformer Tr1, Tr2 with each primary winding connected to an individual set of switches (e.g., Q11, Q12, Q13 and Q14 are connected to primary windings Np11, Np12, Np21 and Np22, respectively), according to some embodiments. Similarly, for a three-port converter 106 with a multi-phase transformer Tr1, Tr2, Trn, each primary winding can be driven with a unique set of switches as shown in system 900D in FIG. 9D (e.g., Qn1 and Qn2 control windings Npn1 and Npn2), according to some embodiments. In systems 900C and 900D as shown in FIG. 9C and FIG. 9D, all sets of primary switches Q11-Qn1 can be driven with only one set of gate signals.

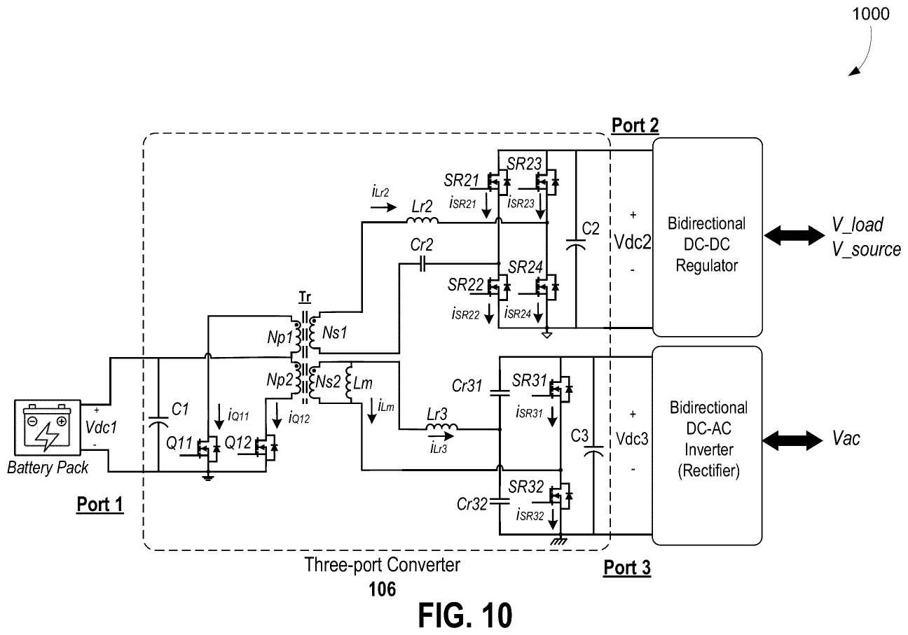

In FIG. 10, a power management and voltage regulation diagram 1000 is shown for a three-port converter 106, the topology of which is previously presented in FIG. 8. In the three-port converter 106 shown in diagram 1000, the low DC voltage Port 1 (Vdc1) is connected to a battery pack, the low DC voltage Port 2 (Vdc2) is connected to a DC-DC voltage regulator to finely tune Vdc2 for a DC load/source, and the high DC voltage Port 3 (Vdc3) is connected to an inverter to receive/feed an AC load or AC grid.

For illustrative purposes, the following assumptions for voltage and power are made for each of the Ports: Vdc1 at Port 1 is a battery with 3V voltage, and it can be charged and discharged at up to 300 W; Vdc2 at Port 2 is a low DC voltage port with a voltage between 20V to 24V, and Port 2 is connected to another DC-DC regulator with a nominal power assumed to be 250 W; and Vdc3 at Port 3 is a high DC voltage port with a voltage between 330V to 360V, and its nominal power is 300 W.

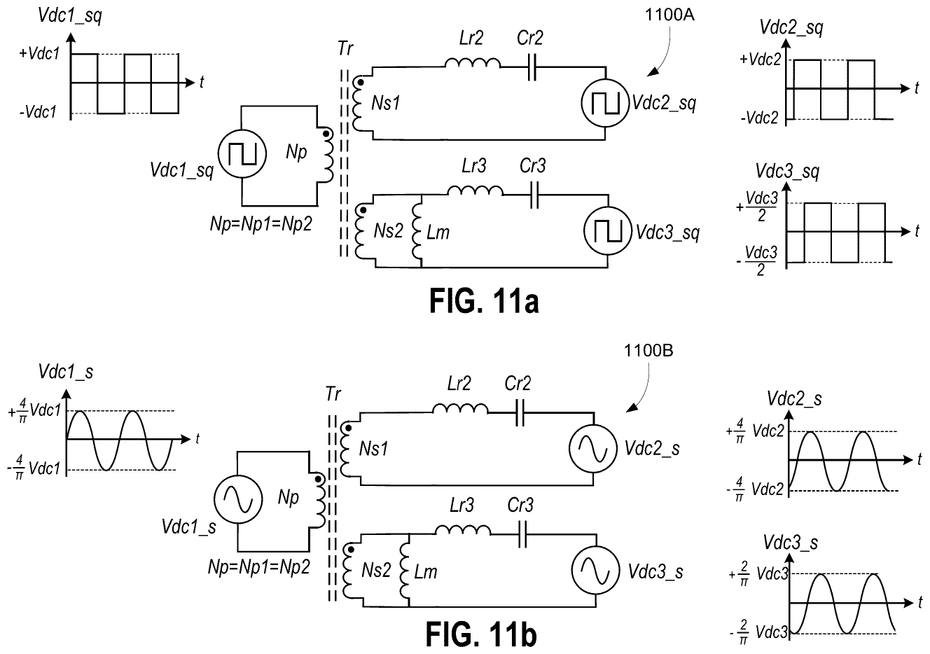

FIG. 11A is an equivalent circuit of the three-port converter circuit as shown in FIG. 10, according to some embodiments. The resonant frequencies of the resonant tanks for Port 2 (i.e., Lr2, Cr2) and Port 3 (i.e., Lr3, Cr3) can be calculated as:

$$Fr 2 = 1 / ( 2 π \sqrt{Lr 2 \times Cr 2} ) \qquad ( 4 )$$

$$Fr 3 = 1 / ( 2 π \sqrt{Lr 3 \times Cr 3} ) \qquad ( 5 )$$

It is assumed that both resonant tanks (Lr2+Cr2, and Lr3+Cr3) are tuned to have the same resonant frequency. When Fr2=Fr3, the resonant tanks are configured such that Lr2×Cr2=Lr3×Cr3.

It is additionally assumed that the three-port converter 106 in FIG. 10 operates at resonant frequency, meaning that the switching frequency (Fs) is equal to the resonant frequency of the tanks (i.e., Fs=Fr2=Fr3). Furthermore, since the primary windings Np1 and Np2 have the same number of turns, they are replaced with one representative winding Np (Np=Np1=Np2).

The switches at each of the Ports (i.e., primary switches Q11 and Q12, and the synchronous rectifiers SR21-SR24 and SR31-SR32) form a square wave voltage waveform, such that the voltage sources (i.e., Vdc1, Vdc2, Vdc3) are replaced with square wave sources, specifically: Vdc1 is replaced by Vdc1_sq, which is a square wave voltage source oscillating between +Vdc1 to −Vdc1; Vdc2 is replaced by Vdc2_sq, which is a square wave voltage source oscillating between +Vdc2 to −Vdc2; and Vdc3 is replaced by Vdc3_sq, which is a square wave voltage source oscillating between +0.5×Vdc3 to −0.5×Vdc3. The amplitude of the square-wave voltage Vdc3_sq is halved due to the use of the voltage doubler rectifier at Port 3, as shown in FIG. 10. Notably, the square wave voltage sources (Vdc1_sq, Vdc2_sq, Vdc3_sq) are not necessarily in phase with each other, and there might be a phase shift between each of them.

Given that the three-port converter 106 in FIG. 10 is assumed to operate at resonant frequency, the fundamental harmonic of the square wave voltage sources can be considered for further analysis using the First Harmonic Approximation (FHA) method. Using FHA, the voltage source values can be expressed as:

$$vdc1\_s ( t ) = \frac{4}{π} \times Vdc 1 \times sin ( ω t ) \qquad ( 6 )$$

$$vdc2\_s ( t ) = \frac{4}{π} \times Vdc 2 \times sin ( ω t ) \qquad ( 7 )$$

$$vdc3\_s ( t ) = \frac{4}{π} \times \frac{Vdc 3}{2} \times sin ( ω t ) = \frac{2}{π} \times Vdc 3 \times sin ( ω t ) \qquad ( 8 )$$

where vdc1_s(t), vdc2_s(t), and vdc3_s(t) are the fundamental voltage harmonics of the square-wave sources, and ω=2πFs. The equivalent DC values can be represented by the Root Mean Square (RMS) values of the voltage sources, which can be calculated as:

$$Vdc 1 \_s = \frac{2 \sqrt{2}}{π} \times Vdc 1 \qquad ( 9 )$$

$$Vdc2\_s = \frac{2 \sqrt{2}}{π} \times Vdc 2 \qquad ( 10 )$$

$$Vdc3\_s = \frac{\sqrt{2}}{π} \times Vdc 3 \qquad ( 11 )$$

FIG. 11B shows an equivalent circuit 1100B using FHA of three-port converter 106 shown in FIG. 10. The following analysis on power management among the Ports and corresponding voltage regulation will be based on the equivalent circuit 1100B.

For the following analysis, three-port converter 106 has the exemplary specifications and component values as listed in Table 1.

TABLE 1
Three-port converter component specifications

| Item | Parameter | Value | |
|---|---|---|---|
| Voltage range for Port 1 | Vdc1 | 3 | V |
| Voltage range for Port 2 | Vdc2 | 20 V-24 V | |
| Voltage range for Port 3 | Vdc3 | 330 V-360 V | |
| Power range for Port 1 | P1 | 300 | W |
| Power range for Port 2 | P2 | 250 | W |
| Power range for Port 3 | P3 | 300 | W |
| Primary winding turn number | Np | 1 | |
| First secondary winding turn number | Ns1 | 8 | |
| Second secondary winding turn number | Ns2 | 58 | |
| Equivalent magnetizing inductance at | Lm | 327 | uH |
| second secondary winding side | | | |
| Resonant inductor at Port 2 | Lr2 | 6 | uH |
| Resonant capacitor at Port 2 | Cr2 | 187 | nF |
| Resonant inductor at Port 3 | Lr3 | 33 | uH |
| Resonant capacitor at port 3 | Cr3 | 34 | nF |

Given the component specifications and equations (4) and (5), the resonant frequency is therefore 150 kHz, which, as previously explained, is the same as the switching frequency (Fs).

Based on the above assumptions, simplifications, and specifications, the control method principle and performance for Modes 1-7 shown in FIG. 2A-FIG. 2G are explained in the following sections using the simplified circuit 1100C (which is based on the three-port converter 106 shown in FIG. 10).

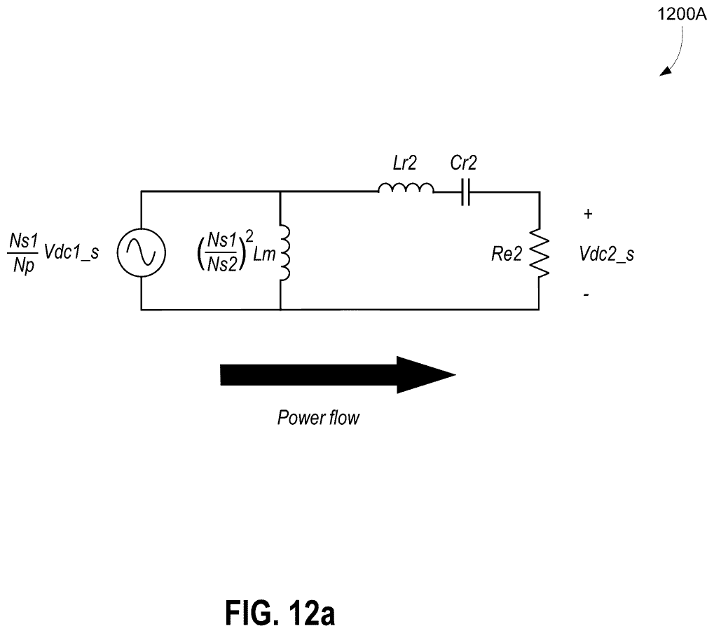

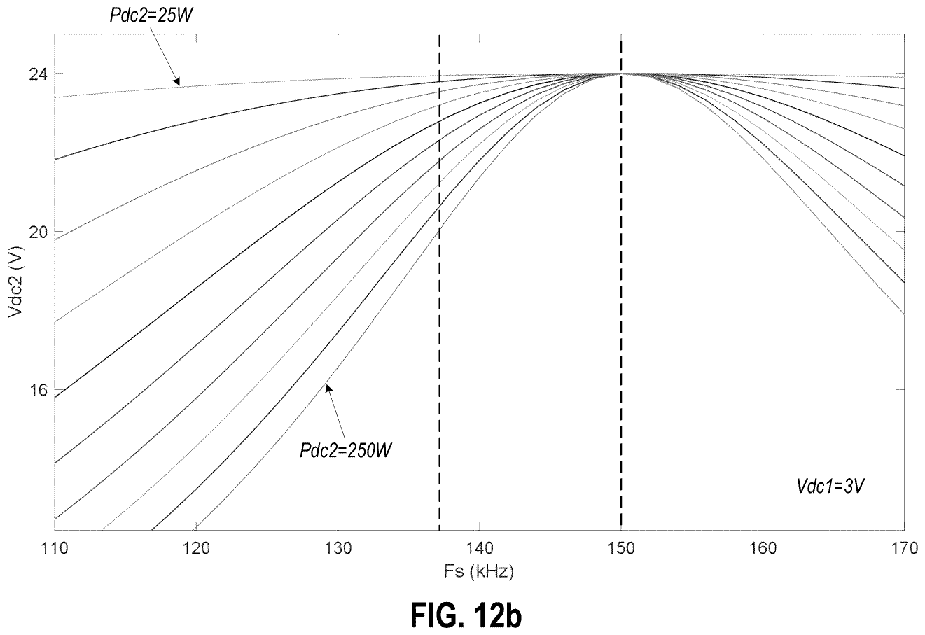

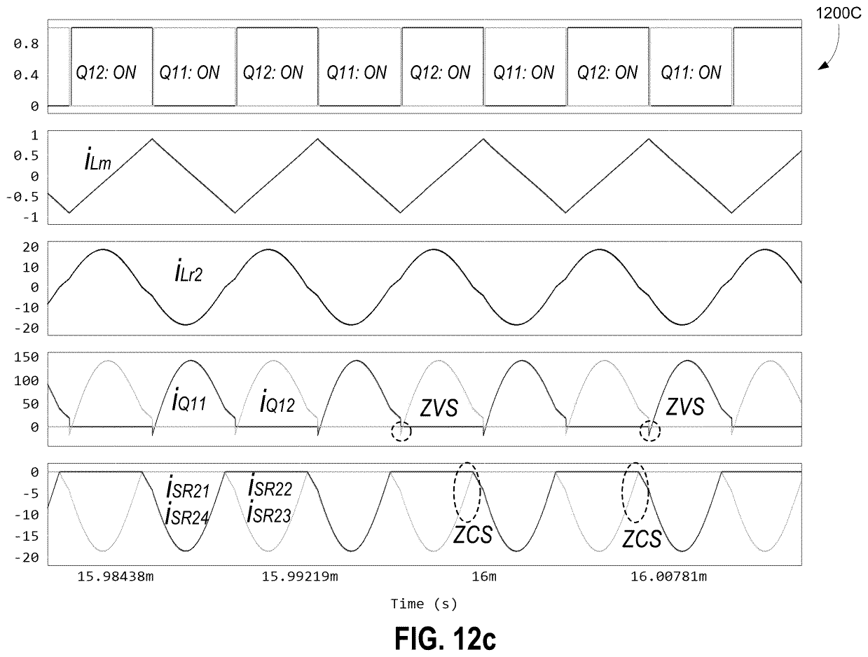

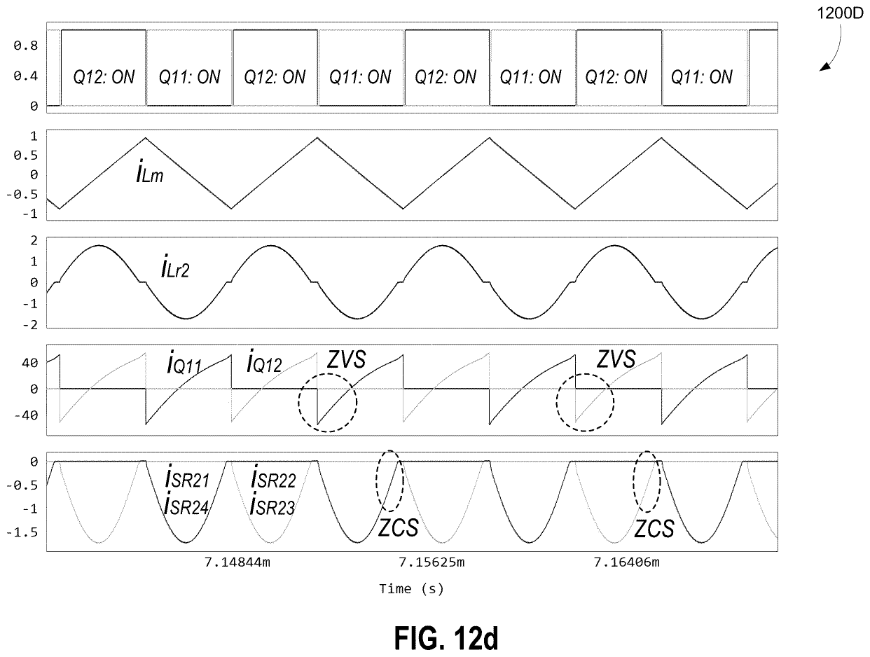

In FIG. 12A-FIG. 12D, power transfer within the three-port converter 106 according to Mode 1 as shown in FIG. 2A is considered. In Mode 1, Port 1 (i.e., Vdc1) transfers power to Port 2 (i.e., Vdc2), power/current at Port 3 (i.e., Vdc3) is zero, consequently the current in the branch including Lr3, Cr3, and Vdc3_s is zero, and Lr3, Cr3, and Vdc3_s are functionally disconnected. FIG. 12A shows the equivalent circuit 1200A for mode 1, wherein: Vdc1_s transfers power through Lm to Port 2 (vdc2_s); the voltage source Vdc1_s is multiplied by the corresponding turn ratio (i.e., Ns1/Np), and the magnetizing inductance Lm is multiplied by the squared turn ratio (i.e., (Ns1/Ns2)²), according to some embodiments.

Since Port 1 delivers power to Port 2, the voltage source at Port 2 is replaced with a resistor representing the load. The current at Port 2 can be assumed to be:

$$i 2 ( t ) = \sqrt{2} \times I 2 \times sin ( ω t ) \qquad ( 12 )$$

where i2(t) is the instantaneous current and I2 is the RMS value of the current at Port 2.

Using equation (12), the average output current at Port 2 can be determined by calculating the average output current during a half switching cycle, which can be expressed as:

$$Iavg 2 = \frac{2}{Ts} {\int }_{2}^{\frac{Ts}{2}} i 2 ( t ) dt = \frac{2 \sqrt{2}}{π} I 2 \qquad ( 13 )$$

where Ts is the switching period (Ts=1/Fs) for converter 106.

The equivalent-load resistance at Port 2 can be derived using the RMS output voltage and RMS output current from Equations (10) and (13), which yields:

$$Re 2 = \frac{Vdc2\_s}{2} = \frac{\frac{2 \sqrt{2}}{π} Vdc 2}{\frac{π}{2 \sqrt{2}} Iavg 2} = \frac{8}{{π}^{2}} RL 2 \qquad ( 14 )$$

where RL2 is the equivalent load resistance at Port 2, which is equal to the corresponding average voltage divided by the average current (Vdc2/Iavg2); and Re2 is the equivalent resistor in the FHA method. Equation (14) shows the relationship between the equivalent load resistance and the FHA resistance.

Given the equivalent circuit 1200A shown in FIG. 12A, Vdc2_s can then be calculated as:

$$Vdc2\_s = \frac{R e 2}{\vert R e 2 + j ( ω Lr 2 - \frac{1}{ω Cr 2} ) \vert} \times \frac{N s 1}{N p} \times Vdc1\_s = \frac{R e 2}{\sqrt{{( R e 2 )}^{2} + {( ω L r 2 - \frac{1}{ω Cr 2} )}^{2}}} \times \frac{N s 1}{N p} \times Vdc1\_s \qquad ( 15 )$$

Substituting Equations (9) and (10) into (15) yields:

$$V d c 2 = \frac{R e 2}{\sqrt{{( R e 2 )}^{2} + {( ω L r 2 - \frac{1}{ω Cr 2} )}^{2}}} \times \frac{N s 1}{N p} \times Vdc 1 \qquad ( 16 )$$

Based on Equation (16) and the component specification provided in Table 1, the voltage for Port 2 at power levels from 25 W to 250 W (from 10% to 100% of the nominal load) versus switching frequency (Fs) is plotted in FIG. 12B, in which each individual curve represents a separate power level between 25 W and 250 W.

As shown in FIG. 12B, at resonant frequency (150 kHz), Vdc2 is 24V regardless of the output power. When the switching frequency deviates from the resonant frequency of 150 kHz, the voltage at Port 2 decreases. At higher output power (i.e., curves positioned lower in FIG. 12B) the voltage drop is steeper, while at lower power levels (i.e., curves positioned higher in FIG. 12B), the voltage curve flattens and the drop is less severe.

When prioritizing efficiency, it is preferrable to set the switching frequency close to, or equal to, the resonant frequency; however, when optimizing for soft switching, it is better to have a switching frequency slightly lower than the resonant frequency, which may enable zero-voltage switching when component tolerance is considered. Accordingly, as shown in FIG. 12B, switching frequencies ranging from 138 kHz to 150 kHz (as indicated by the two vertical dotted lines) can effectively regulate Vdc2 to remain within 20V to 24V while operating anywhere within the power range between 25 W to 250 W.

In other words, by changing the switching frequency Fs of converter 106 and at the same time, allowing the voltage at Port 2, Vdc2, to be varied, the power Pdc2 at Port 2 can be controlled to the desired value. For example, if the desired power at Port 2 is Pdc2=250 W, the switching frequency, Fs, can be set to around Fs=150 kHz and at this operating condition, the voltage at Port 2 can be around Vdc2=24V. Another option to obtain Pdc2=250 W could be to set the switching frequency to around Fs=138 kHz and the voltage at Port 2 to around Vdc2=19.5V. Similarly, if the required power at Port 2 is around Pdc2=25 W, the switching frequency can be changed from 138 kHz to 150 kHz and the voltage at Port 2 (Vdc2) may be set to 24V.

Therefore, since the ESS battery voltage at Port 1 may be fixed, when operating in Mode 1, the control strategy for converter 106 may be to modulate the switching frequency of converter 106 to obtain a desired power at Port 2. Further, since multiple switching frequencies can be used to obtain the same power at Port 2, the voltage at Port 2 (i.e., Vdc2) can be varied based on the use-case.

FIG. 12C shows the simulation results 1200C for power transfer from Vdc1 to Vdc2, where the output power is 250 W (full power). The corresponding current directions are shown in FIG. 10. In simulation 1200C, the switching frequency is 142 kHz, and Vdc2 is regulated at 22V. Q11 and Q12 operate as the main switches, and SR21, SR22, SR23, and SR24 are operating as synchronous rectifiers. From top to bottom, FIG. 12C shows the gate signals for switches Q11 and Q12; magnetizing inductance current iLm; resonant tank inductor current at Port 2 (i.e., iLr2); battery side switch current, iQ11 and iQ12; and synchronous rectifier current, iSR21, iSR22, iSR23, and iSR24.

The primary switches Q11 and Q12 achieve Zero Voltage Switching (ZVS) during turn-on because their current is negative (close to −20 A) at the instant of switching, which minimizes switching losses at that moment. During turn-off, the switches Q11 and Q12 carry approximately 20 A with a voltage of roughly 6 V (2×3 V), resulting in very low switching loss.

Similarly, the synchronous rectifiers operate under Zero Current Switching (ZCS) during turn-off, as indicated by the zero-crossing points of their current waveforms iSR21, iSR22, iSR23, and iSR24, effectively eliminating switching losses in these devices. This combination of ZVS for the primary switches Q11, Q12 (i.e., turned on when the current through them is negative) and ZCS for the synchronous rectifiers iSR21, iSR22, iSR23, iSR24 (i.e., turned on or off when the current is zero) improves efficiency by reducing switching losses across the converter 106.

FIG. 12D shows the simulation results 1200D for power transfer from Vdc1 to Vdc2 (Mode 1) at 25 W (10% of full power), where the switching frequency is 138 kHz, Vdc2 is regulated at 24V, Q11 and Q12 are operating as the main switches, and SR21, SR22, SR23, and SR24 are operating as synchronous rectifiers, according to some embodiments.

As can be seen in FIG. 12D, the gate signals for switches Q11 and Q12 are shown along with the switch current iQ11 and iQ12 for Port 1. Since the switch currents iQ11 and iQ12 are negative at the turn ON moment (almost −55 A), they are being turned ON at ZVS condition, leading to zero switching loss at the time of turn-on. Also, as switches iQ11 and iQ12 turn OFF at about 55 A, considering the voltage across the switches iQ11 and iQ12 is 2×3V, the switching loss at the time of turn-off is minimal.

Further, in FIG. 12D, the synchronous rectifier currents iSR21, iSR22, iSR23, and iSR24 are shown for synchronous rectifiers SR21, SR22, SR23, and SR24 of Port 2. The synchronous rectifiers are being turned OFF under ZCS, which eliminates switching losses. Lastly, FIG. 12C shows the magnetizing inductance current iLm and the resonant tank inductor current iLr3 for Port 2.

Therefore, based on the simulation results for power transfer from Vdc1 to Vdc2 (Mode 1) under two load conditions (i.e., full load (FIG. 12C) and light load (FIG. 12D)), the effective voltage regulation and power delivery from Port 1 to Port 2 by the converter 106 is validated.

The slight differences between the curves in FIG. 12B and the simulation results in FIGS. 12C and 12D are due to the approximations made during the analysis.

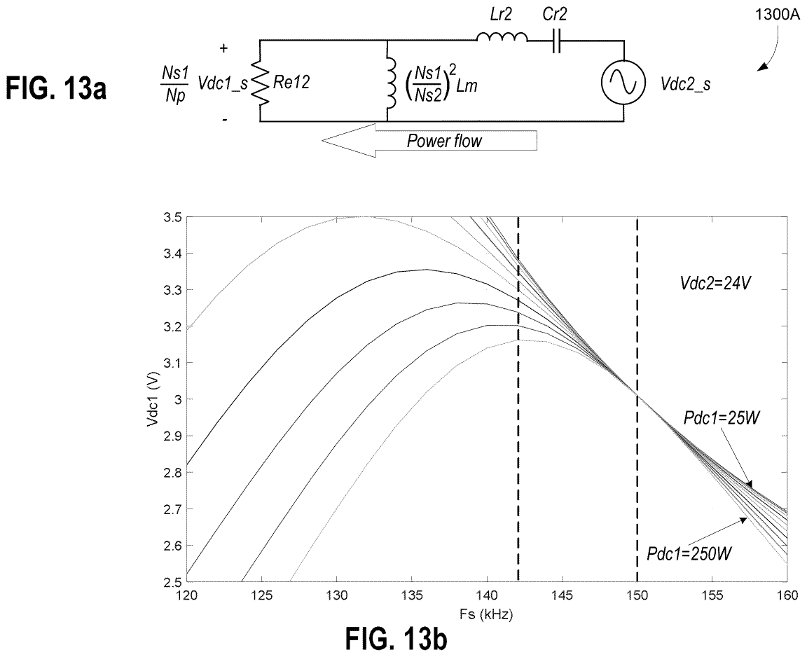

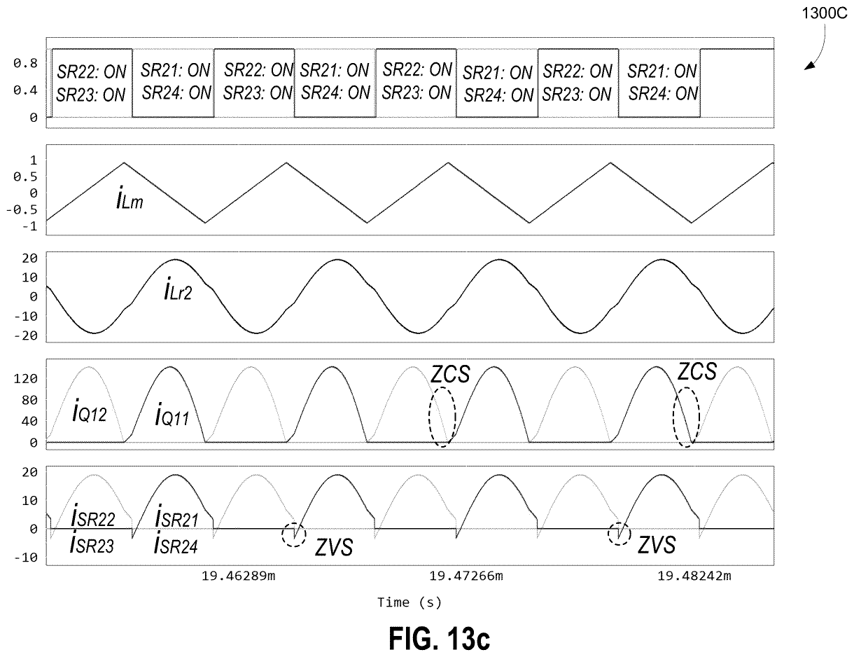

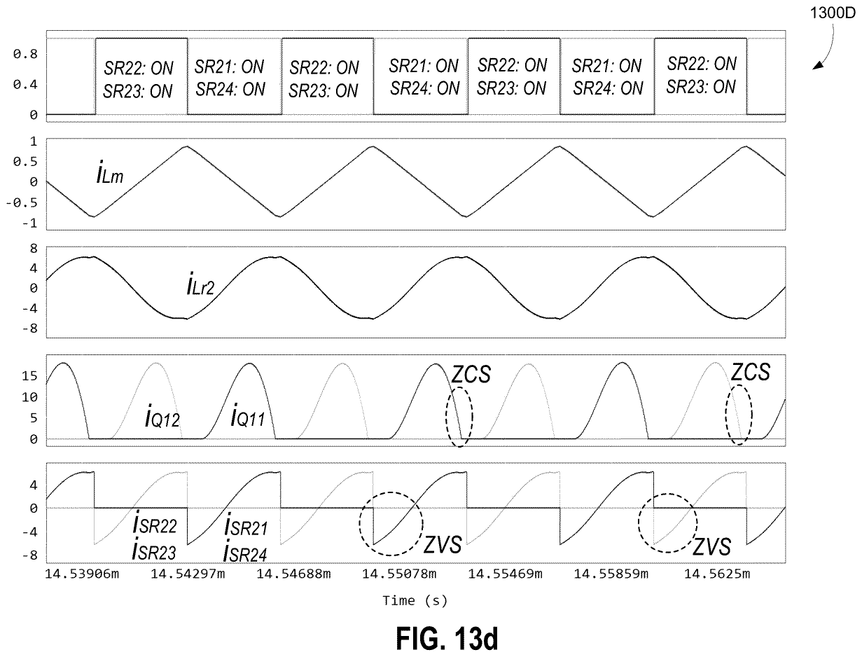

In FIG. 13A-FIG. 13D, power transfer within the three-port converter 106 shown in FIG. 10 according to Mode 2 as shown in FIG. 2(b) is considered. In Mode 2, Port 2 (i.e., Vdc2) transfers power to Port 1 (i.e., Vdc1). Power and current at Port 3 (i.e., Vdc3) is zero, consequently the current in the branch including Lr3, Cr3, and Vdc3_s is zero, and Lr3, Cr3, and Vdc3_s are functionally disconnected.

FIG. 13A is an equivalent circuit 1300A of a three-port converter circuit for operation in Mode 2 as shown in FIG. 2B, according to some embodiments. The equivalent load resistance is RL1, and using the same methodology explained previously regarding equation (14), the equivalent FHA resistance value at Port 2 is:

$$R e 12 = \frac{8}{{π}^{2}} {( \frac{N s 1}{N p} )}^{2} R L 1 \qquad ( 17 )$$

Considering the equivalent circuit 1300A shown in FIG. 13A, Vdc1_s can be calculated as:

$$\frac{N s 1}{N p} \times Vdc1\_s = \frac{\vert j ω \times {( \frac{N s 1}{N s 2} )}^{2} \times L r m \times R e 12 \vert}{\vert \begin{matrix}j ω \times {( \frac{N s 1}{N s 2} )}^{2} \times L r m \times R e 12 + \\ j ( ω Lr 2 \frac{1}{ω Cr 2} ) ( R e 12 + j ω \times {( \frac{N s 1}{N s 2} )}^{2} \times L rm )\end{matrix} \vert} \times Vdc2\_s \qquad ( 18 )$$

$$Vdc 1 = \frac{N p}{N s 1} \times \frac{\vert j ω \times {( \frac{N s 1}{N s 2} )}^{2} \times L r m \times R e 12 \vert}{\vert \begin{matrix}j ω \times {( \frac{N s 1}{N s 2} )}^{2} \times L r m \times R e 12 + \\ j ( ω Lr 2 \frac{1}{ω Cr 2} ) ( R e 12 + j ω \times {( \frac{N s 1}{N s 2} )}^{2} \times L rm )\end{matrix} \vert} \times V d c 2 \qquad ( 19 )$$

Based on equation (19) and the component specification provided in Table 1, the voltage for Port 1 (Vdc1) at power levels from 25 W to 250 W (from 10% to 100% of the nominal load) versus switching frequency (Fs) is plotted in FIG. 13B, in which each individual curve represents a separate power level between 25 W and 250 W.

As shown in FIG. 13B, at resonant frequency (150 kHz), Vdc1 is 3V regardless of the output power. As the switching frequency Fs deviates from 142 kHz to higher values, the voltage at Port 1 (Vdc1) decreases.

In order to manage the delivered power to Port 1 (Vdc1), the ESS battery current connected to Port 1 has to be controlled. Since Port 1 is connected to a battery pack with a 3V voltage level, the converter has to apply a voltage slightly higher than 3V to inject current into the battery. This current value depends on the parasitic impedances that are present (e.g., transformer leakage impedance, and switch resistance) and/or battery pack impedance. In practical application, these impedance values are found to be around a few milliohms (e.g., roughly 2 mΩ) in total. If the converter operates at a switching frequency that regulates the voltage at 3.1V, then a current of (3.1V−3V)/0.00202=50 A will be injected into the ESS battery.

Furthermore, it is preferrable to set the switching frequency Fs close to or equal to the resonant frequency Fr in order to improve efficiency; however, when optimizing for soft switching, it is better to have a switching frequency Fs slightly lower than the resonant frequency Fr. Accordingly, as shown in FIG. 13B, a switching frequency ranging from 142 kHz to 150 kHz (as indicated by the two vertical dotted lines) can effectively control the power flow from Port 2 to Port 1 while operating anywhere within the power range between 25 W to 250 W.

FIG. 13C shows the simulation results 1300C for power transfer from Port 2 (Vdc2) to Port 1 (Vdc1) (Mode 2), where the output power is 250 W (full power), according to some embodiments. The corresponding current directions are shown in FIG. 10. The switching frequency is 144 kHz, and Vdc2 is set at 24V. The ESS battery at Port 1 is modeled as an ideal voltage source with 3V voltage level. Under these conditions, a current of 83 A is being injected into the ESS battery at Port 1. SR21, SR22, SR23, and SR24 operate as the main switches, and Q11 and Q12 are operating as synchronous rectifiers.

As can be seen in FIG. 13C, the gate signals for switches SR21, SR22, SR23, and SR24 are shown along with the main switch currents iSR21, iSR22, iSR23, and iSR24. Since the switch currents are negative at the turn ON moment (almost −3 A), they are being turned ON at ZVS condition, leading to zero switching loss at the time of turn-on. Also, as the switches turn OFF at almost 3 A, considering a voltage of 24V across the switches, the switching loss at the time of turn-off is minimal.

Further, in FIG. 13C, the synchronous rectifier currents iQ12 and iQ11 are shown for switches Q12 and Q11 of Port 1. As can be seen, the switches Q11 and Q12 of Port 1, acting as synchronous rectifiers, are being turned OFF under ZCS, which eliminates switching losses. Lastly, FIG. 13C shows the magnetizing inductance current iLm and the resonant tank inductor current iLr2 for Port 2.

FIG. 13D shows the simulation results 13D for power transfer from Vdc2 to Vdc1 (Mode 2), where the output power is 25 W (10% of full power), the switching frequency is 145.5 kHz, and Vdc2 is set at 24V, according to some embodiments. The ESS battery at Port 1 is modeled as an ideal voltage source with 3V voltage level. Under these conditions, a current of 8.3 A is being injected into the ESS battery at Port 1. SR21, SR22, SR23, and SR24 operate as the main switches, and Q11 and Q12 are operating as synchronous rectifiers.

As can be seen in FIG. 13D, the gate signals for main switches SR21, SR22, SR23, and SR24 are shown along with the main switch currents iSR21, iSR22, iSR23, and iSR24. Since the main switch currents are negative at the turn ON moment (almost −6 A), they are being turned ON at ZVS condition, leading to zero switching loss at the time of turn-on. Also, as the main switches SR21, SR22, SR23, and SR24 turn OFF at almost 6 A, considering a voltage of 24V across the main switches, the switching loss at the time of turn-off is minimal.

Further, in FIG. 13D, the synchronous rectifier currents iQ12 and iQ11 are shown for switches Q12 and Q11 of Port 1, acting as synchronous rectifiers. As can be seen, Q11 and Q12 of Port 1 are being turned OFF under ZCS, which eliminates switching losses. Lastly, FIG. 13D shows the magnetizing inductance current iLm and the resonant tank inductor current iLr2 for Port 2.

Therefore, based on the simulation results for power transfer from Vdc2 to Vdc1 (Mode 2) in the three-port converter 106 under two load conditions (i.e., full load (FIG. 13C) and light load (FIG. 13D)), the effective voltage regulation and power delivery from Port 2 to Port 1 by the converter is validated.

The slight differences between the curves in FIG. 13B and the simulation results in FIGS. 13C and 13D are due to the approximations made during the analysis.

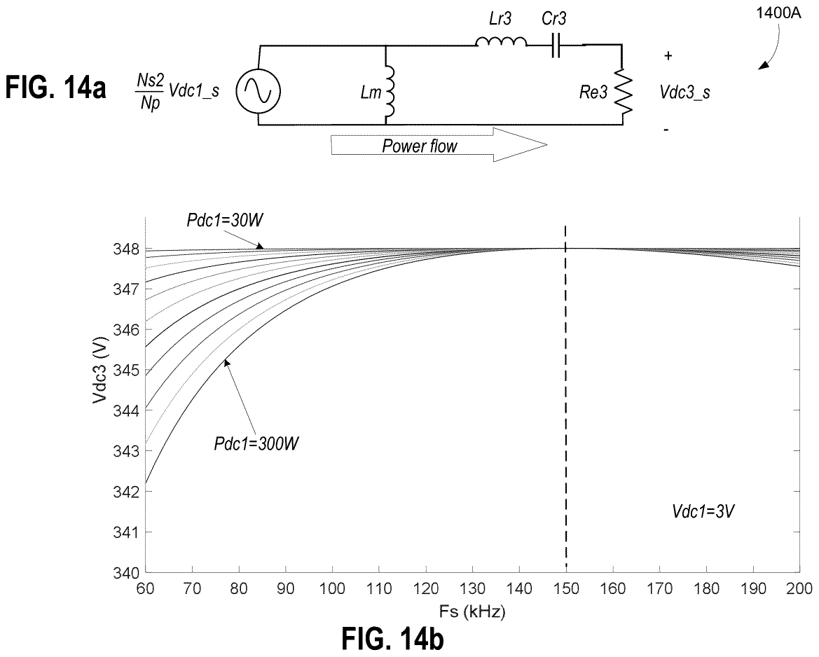

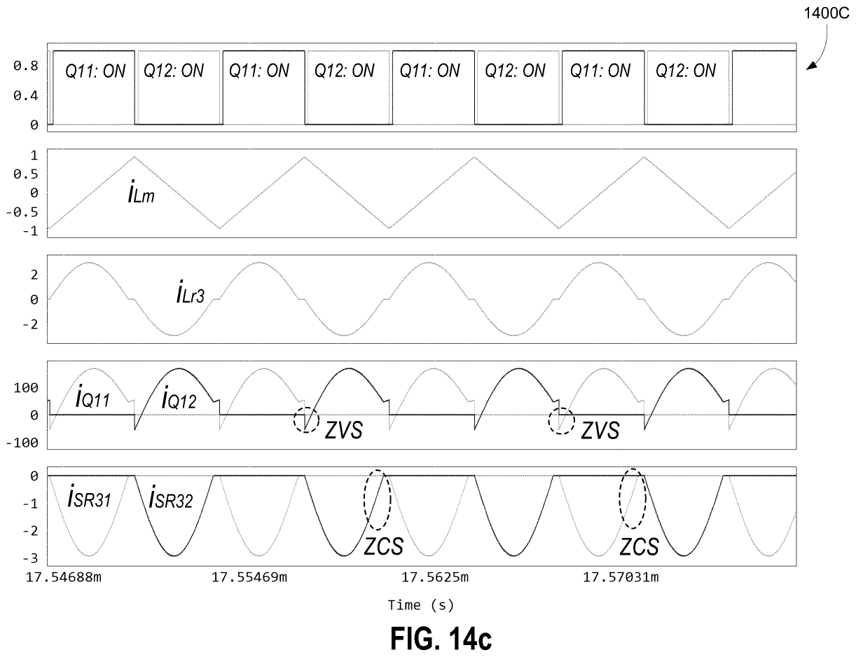

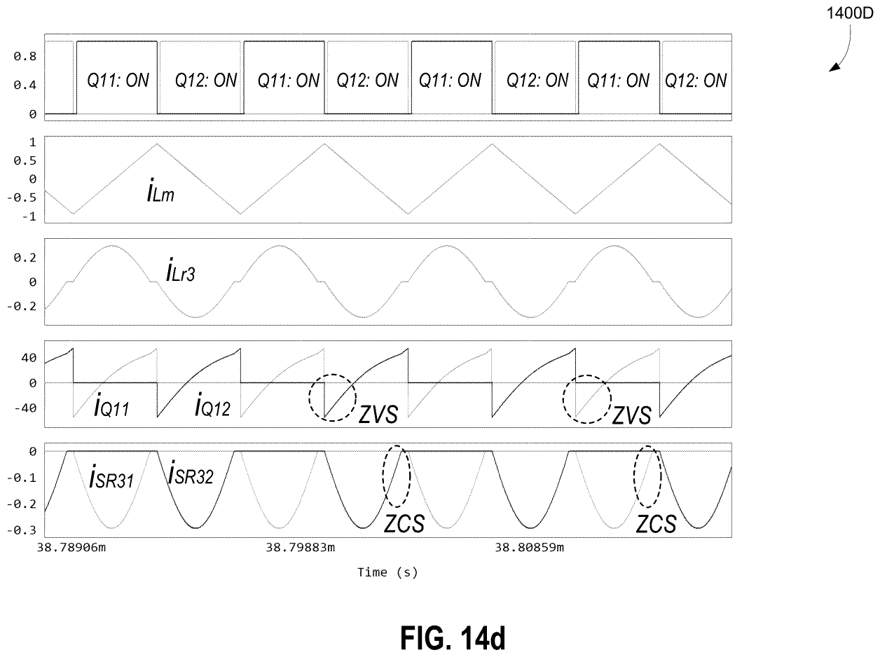

In FIG. 14A-FIG. 14D, the power transfer within three-port converter 106 according to Mode 3 shown in FIG. 2C is considered. In this mode Port 1 (i.e., Vdc1) transfers power to Port 3 (i.e., Vdc3), and the power/current at Port 2 (i.e., Vdc2) is zero, so the current in the branch including Lr2, Cr2, and Vdc2_s is zero, and these two components and the source are disconnected. The equivalent circuit 1400A for converter 106 in Mode 3 is shown in FIG. 14A, where Vdc1_s is acting as a source which transfers power to Vdc3_s acting as a load, according to some embodiments. The voltage source Vdc1_s is multiplied by the corresponding turn ratio between tertiary winding Ns2 and primary winding Np (i.e., Ns2/Np).

Using the same methodology explained for Equation (14) above, the equivalent resistor value can be determined using the relation between the equivalent load resistance and the first harmonic approximation resistance for Port 3 as shown below in Equation (20):

$$R e 3 = \frac{8}{{π}^{2}} R L 3 \qquad ( 20 )$$

where RL3 is the equivalent load resistance at Port 3. Equation (20) shows the relation between the equivalent load resistance and the first harmonic approximate resistance.

Considering the equivalent circuit 1400A as shown in FIG. 14A, Vdc3_s can be expressed as:

$$\begin{matrix}Vdc3\_s = \frac{R e 3}{\vert R e 3 + j ( ω L r 3 - \frac{1}{ω Cr 3} ) \vert} \times \frac{N s 2}{N p} \times Vdc1\_s \\ = \frac{R e 3}{\sqrt{{( R e 3 )}^{2} + {( ω L r 3 - \frac{1}{ω Cr 3} )}^{2}}} \times \frac{N s 2}{N p} \times Vdc1\_s\end{matrix} \qquad ( 21 )$$

Substituting Equations (9) and (11) into (21) yields:

$$V d c 3 = 2 \times \frac{R e 3}{\sqrt{{( R e 3 )}^{2} + {( ω L r 3 - \frac{1}{ω Cr 3} )}^{2}}} \times \frac{N s 2}{N p} \times Vdc 1 \qquad ( 22 )$$

Based on the equivalent circuit 1400A, the numbers provided in Table 1, and equation (22), the voltage for Port 3 for various power levels ranging from 30 W to 300 W (from 10% to 100% of the nominal load) versus switching frequency (Fs) is plotted in FIG. 14B. In FIG. 14B, at resonant frequency (150 kHz), Vdc3 becomes 348V, regardless of the output power. As the switching frequency deviates from the resonant frequency, the voltage at Port 3 slightly decreases. As setting the switching frequency near the resonant frequency (near resonant mode) increases the efficiency of converter 106, setting the switching frequency below the resonant frequency (i.e., below resonant mode) enables soft switching.

When the switching frequency Fs exceeds the resonant frequency Fr, the turn-off current in the primary-side switches corresponds to the resonant current, which is relatively high compared to the condition where Fs<Fr. Under this above-resonance condition, there is no dead time between the turn-off of one synchronous rectifier and the turn-on of the next, resulting in additional conduction and switching losses. Conversely, when Fs<Fr, a dead time naturally occurs during which both the outgoing and incoming synchronous rectifiers remain off. This interval ensures that the synchronous rectifiers achieve ZCS, thereby minimizing switching losses. Therefore, since variation in Vdc3 is insignificant in respect to the switching frequency (as shown in FIG. 14B), it may be preferred to set the switching frequency below the resonant frequency for operation of converter 106 under Mode 3.

FIG. 14C shows the simulation results for power transfer from Vdc1 to Vdc3 (Mode 2) in converter 106, where the output power is 300 W (full power), according to some embodiments. The corresponding current directions are shown in FIG. 10. The switching frequency was set at 140 kHz (below the resonant frequency of 150 kHz), and Vdc3 is regulated at 347V. Q11 and Q12 are operating as the main switches, and SR31 and SR32 are operating as synchronous rectifiers.

As can be seen in FIG. 14C, the gate signals for switches Q11 and Q12 are shown along with the switch current iQ11 and iQ12 for Port 1. Since the switch currents iQ11 and iQ12 are negative at the turn ON moment (almost −50 A), they are being turned ON at ZVS condition, leading to zero switching losses at the time of turn-on. Also, as switches Q1 and Q2 turn OFF at about 50 A, considering voltage across the switches Q1 and Q2 is 2×3V, the switching loss at the time of turn-off is minimal.

Further, in FIG. 14C, the synchronous rectifier currents iSR31 and iSR32 are shown for synchronous rectifiers SR31 and SR32 of Port 3. As can be seen, the synchronous rectifiers SR31 and SR32 of Port 3 are being turned OFF under ZCS, which eliminates switching losses. Lastly, FIG. 14C shows the magnetizing inductance current iLm and the resonant tank inductor current iLr3 for Port 3.

FIG. 14D shows the simulation results for power transfer from Vdc1 to Vdc3 (Mode 3) in converter 106, where the output power is 30 W (10% of full power), according to some embodiments. The current directions are shown in FIG. 10. The switching frequency was set at 140 kHz (below the resonant frequency of 150 kHz), and Vdc3 is regulated at 348V. Q11 and Q12 are operating as the main switches, and SR31 and SR32 are operating as synchronous rectifiers.

As can be seen in FIG. 14C, the gate signals for switches Q11 and Q12 are shown along with the switch currents iQ11 and iQ12 for Port 1. Since the switch currents iQ11 and iQ12 are negative at the turn ON moment (almost −55 A), they are being turned ON at ZVS condition, leading to zero switching losses at the time of turn-on. Also, as switches Q1 and Q2 turn OFF at about 50 A, considering voltage across the switches Q1 and Q2 is 2×3V, the switching loss at the time of turn-off is minimal.

Further, in FIG. 14D, the synchronous rectifier current iSR31 and iSR32 is shown for synchronous rectifiers SR31 and SR32 of Port 3. As can be seen, the synchronous rectifiers SR31 and SR32 of Port 3 are being turned OFF under ZCS, which eliminates switching losses. Lastly, FIG. 14C shows the magnetizing inductance current iLm and the resonant tank inductor current iLr3 for Port 3.

Therefore, based on the simulation results for power transfer from Vdc1 to Vdc3 (Mode 3) in converter 106 under two load conditions (i.e., full load (FIG. 14C) and light load (FIG. 14D)) the effective voltage regulation and power delivery from Port 1 to Port 3 by converter 106 (i.e., Mode 3) is validated.

The slight differences between the curves in FIG. 14B and the simulation results in FIGS. 14C and 14D are due to the approximations made during the analysis.

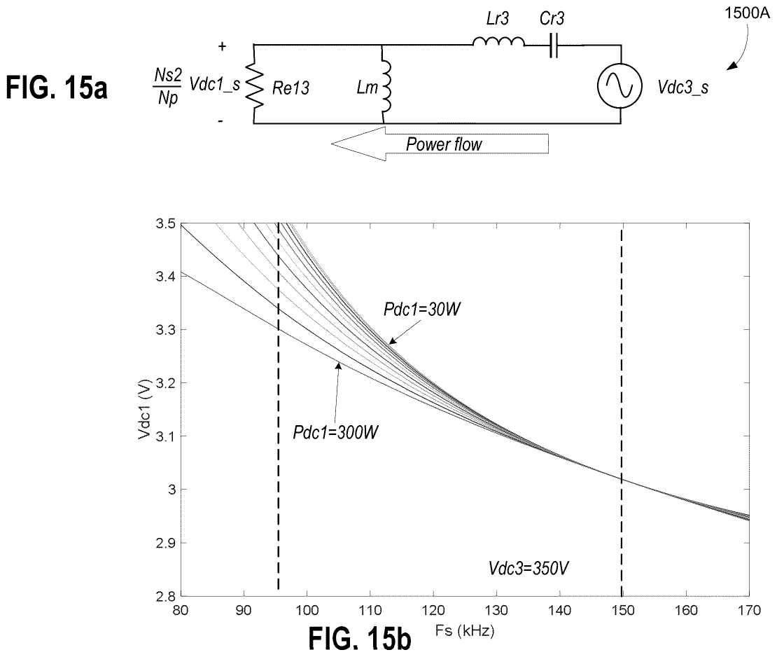

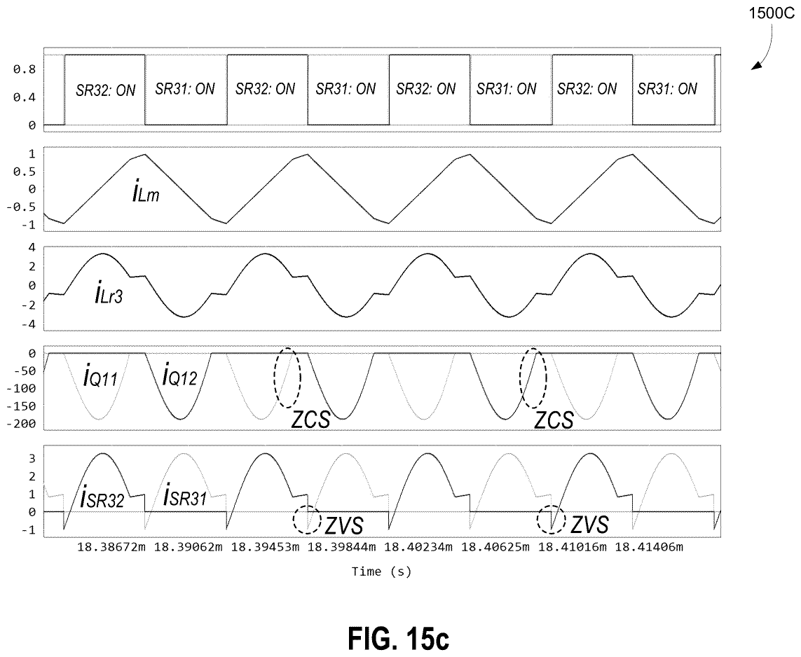

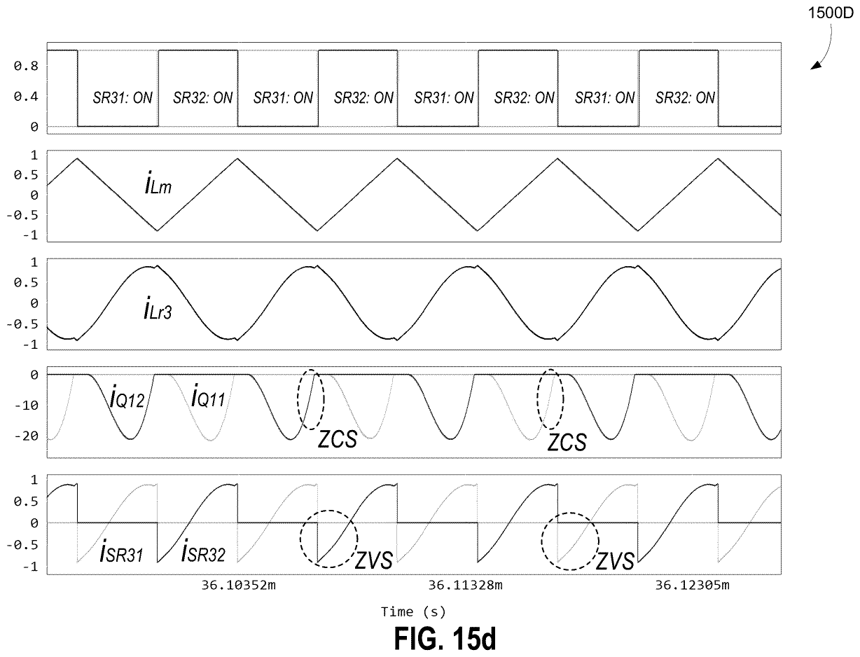

In FIG. 15A-FIG. 15D, power transfer within the three-port converter 106 shown in FIG. 10 according to Mode 4 as shown in FIG. 2D is considered. In Mode 4, Port 3 (i.e., Vdc3) transfers power to Port 1 (i.e., Vdc1), power/current at Port 2 (i.e., Vdc2) is zero, consequently the current in the branch including Lr2, Cr2, and Vdc2_s is zero, and Lr2, Cr2, and Vdc2_s are functionally disconnected. The voltage source Vdc1_s is multiplied by the corresponding turn ratio (Ns2/Np).

The equivalent circuit 1500A for three-port converter 106 in Mode 4 is shown in FIG. 15A, according to some embodiments. The equivalent load resistance is RL1, and using the same methodology explained for Equation (14) above, the equivalent FHA resistance value at Port 3 is:

$$R e 13 = {( \frac{N s 2}{N p} )}^{2} \frac{8}{{π}^{2}} R L 1 \qquad ( 23 )$$

where RL1 is the equivalent load resistance at Port 1. Equation (23) shows the relationship between the equivalent load resistance and the FHA resistance of Port 1.

Considering the equivalent circuit shown in FIG. 15A, Vdc1_s can be calculated as:

$$\frac{N s 2}{N p} \times Vdc1\_s = \frac{\vert j ω Lrm \times R e 13 \vert}{\vert j ω Lrm \times R e 13 + j ( ω Lr 3 \frac{1}{ω Cr 3} ) ( R e 13 + j ω Lrm ) \vert} \times Vdc3\_s \qquad ( 24 )$$

Substituting Equations (9) and (11) into (24) yields:

$$Vdc 1 = 0.5 \times \frac{N p}{N s 2} \times \frac{\vert j ω Lrm \times R e 13 \vert}{\vert j ω Lrm \times R e 13 + j ( ω Lr 3 \frac{1}{ω Cr 3} ) ( R e 13 + j ω Lrm ) \vert} \times Vdc 3 \qquad ( 25 )$$

Based on Equation (25) and the component specification provided in Table 1, the voltage for Port 1 at power levels from 30 W to 300 W (from 10% to 100% of the nominal load) versus switching frequency (Fs) is plotted in FIG. 15B, in which each individual curve represents a separate power level between 25 W and 250 W.

As shown in FIG. 15B, at resonant frequency (150 kHz), Vdc1 is 3V regardless of the output power. As the switching frequency Fs increases, the voltage at Port 1 (vdc1) decreases.

In order to manage the delivered power to Port 1 (Vdc1), the ESS battery current has to be controlled. Since Port 1 is connected to an ESS battery with a 3V voltage level, the three-port converter 106 has to apply a voltage to Port 1 (Vdc1) that is slightly higher than 3V in order to inject current into the ESS battery. The value of the current injected into Port 1 depends on the parasitic impedances that are present (e.g., transformer leakage impedance, and switch resistance, ESS battery impedance). In practical application, these impedance values are found to be around a few milliohms (e.g., roughly 2 mΩ) in total. If the converter 106 operates at a switching frequency Fs that regulates the voltage at 3.1V, then a current of (3.1V−3V)/0.0020=50 A will be injected into the battery.

Furthermore, when prioritizing efficiency, it is preferrable to set the switching frequency Fs close to or equal to the resonant frequency Fr; however, when optimizing for soft switching, it is better to have a switching frequency Fs slightly lower than the resonant frequency Fr. Accordingly, as shown in FIG. 15B, a switching frequency ranging from 95 kHz to 150 kHz (as indicated by the two vertical dotted lines) can effectively control the power flow from Port 3 to Port 1 while operating anywhere within the power range between 30 W to 300 W.

FIG. 15C shows the simulation results 1500C for power transfer from Vdc3 to Vdc1 (Mode 4), where the output power is 300 W (full power), according to some embodiments. The corresponding current directions are shown in FIG. 10. The switching frequency is 121 kHz, and Vdc3 is regulated at 330V. The ESS battery at Port 1 is modeled as an ideal voltage source with 3V voltage level. SR31 and SR32 are operating as the main switches and Q11 and Q12 are operating as synchronous rectifiers.

As can be seen in FIG. 15C, the gate signals for switches SR31 and SR32 are shown along with the main switch currents iSR31, and iSR32. Since the switch currents are negative at the turn ON moment (about −1 A), SR31 and SR32 are being turned ON at ZVS condition, leading to zero switching loss at the time of turn-on. Also, as the switches SR31 and SR32 turn OFF at almost 1 A, considering a voltage of 330V across the switches, the switching loss at the time of turn-off is minimal.

Further, in FIG. 15C, the switches Q11 and Q12 of Port 1 acting as synchronous rectifiers have switch currents iQ12 and iQ11. As can be seen, the switches Q11 and Q12 of Port 1 are being turned OFF under ZCS, which eliminates switching losses. Lastly, FIG. 15C shows the magnetizing inductance current iLm and the resonant tank inductor current iLr3 for Port 3.

FIG. 15D shows the simulation results 1500D for power transfer from Vdc3 to Vdc1 (Mode 4), where the output power is 30 W (10% of full power), according to some embodiments. The current directions are shown in FIG. 10. The switching frequency is 121 kHz, and Vdc3 is regulated at 330V. SR31 and SR32 operate as the main switches, and switches Q11 and Q12 operate as synchronous rectifiers.

As can be seen in FIG. 15D, the gate signals for switches SR31 and SR32 are shown along with the main switch currents iSR31 and iSR32. Since the switch currents iSR31 and iSR32 are negative at the turn ON moment (about −1A), they are being turned ON at ZVS condition, leading to zero switching loss at the time of turn-on. Also, as the switches SR31 and SR32 turn OFF at almost 1 A, considering a voltage of 330V across the switches SR31 and SR32, the switching loss at the time of turn-off is minimal.

Further, in FIG. 15D, the switches Q12 and Q11 of Port 1 acting as synchronous rectifiers have a switch current of iQ12 and iQ11. As can be seen, the synchronous rectifiers Q11 and Q12 of Port 1 are being turned OFF under ZCS, which eliminates switching losses. Lastly, FIG. 15(d) shows the magnetizing inductance current iLm and the resonant tank inductor current iLr3 for Port 3.

Therefore, based on the simulation results 1500C and 1500D for power transfer from Vdc3 to Vdc1 (Mode 4) in the converter 106 under two load conditions (i.e., full load (FIG. 15C) and light load (FIG. 15D)), the effective voltage regulation and power delivery from Port 3 to Port 1 by the converter 106 is validated.

The slight differences between the curves in FIG. 15B and the simulation results in FIGS. 15C and 15D are due to the approximations made during the analysis.

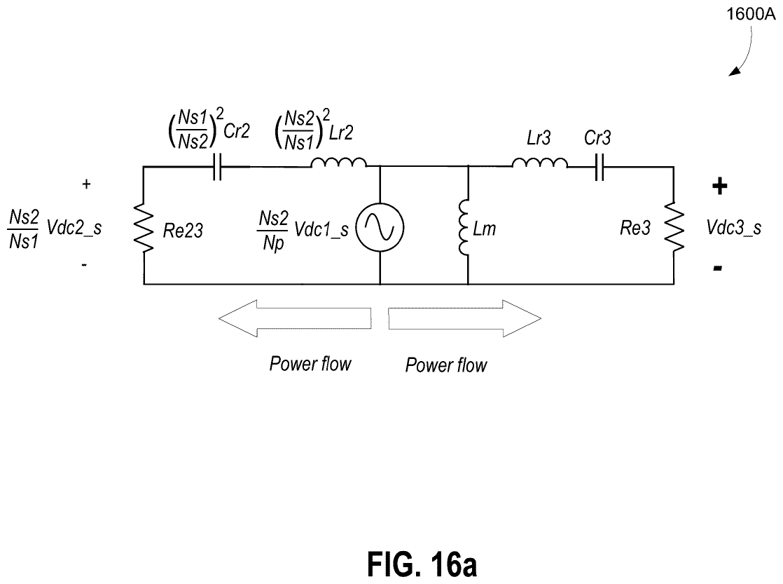

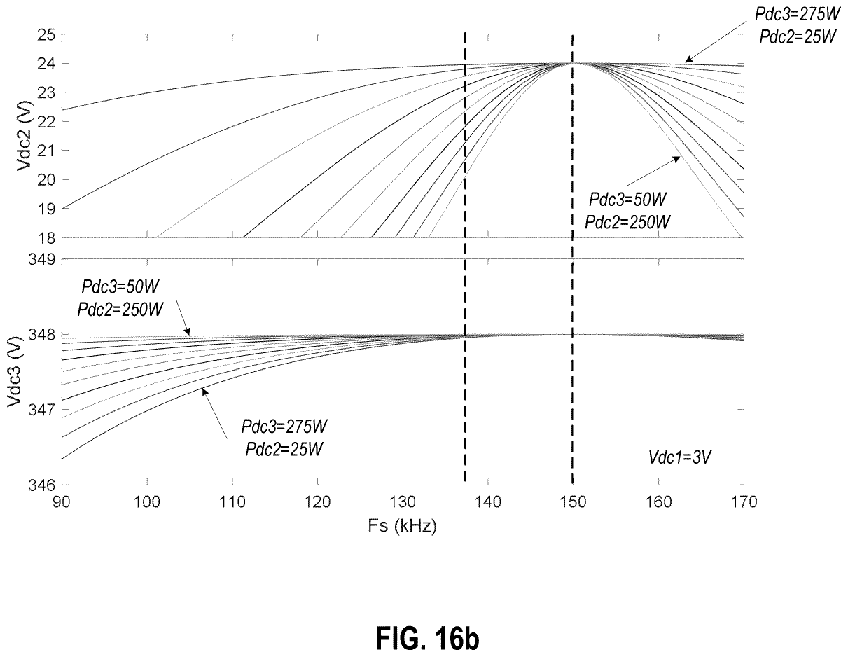

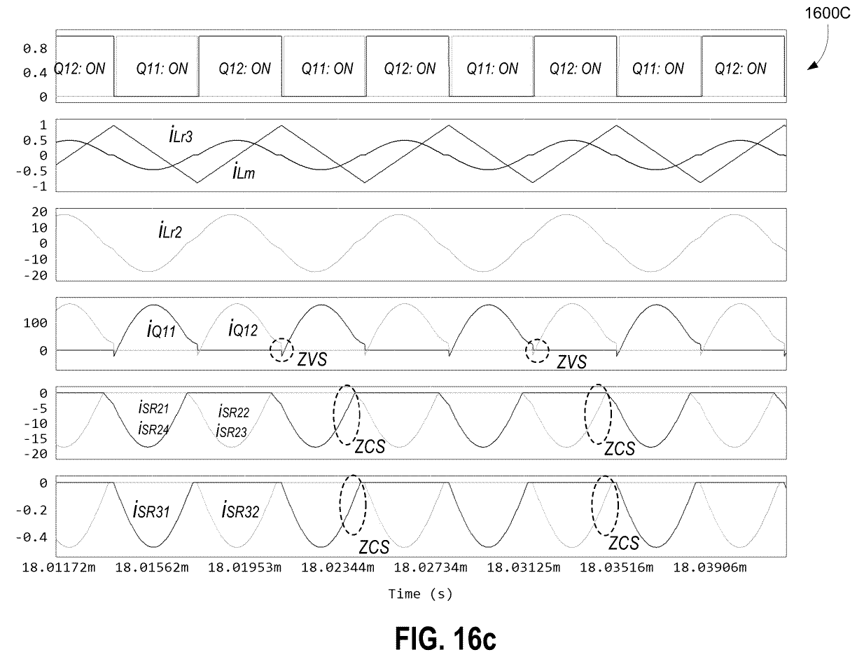

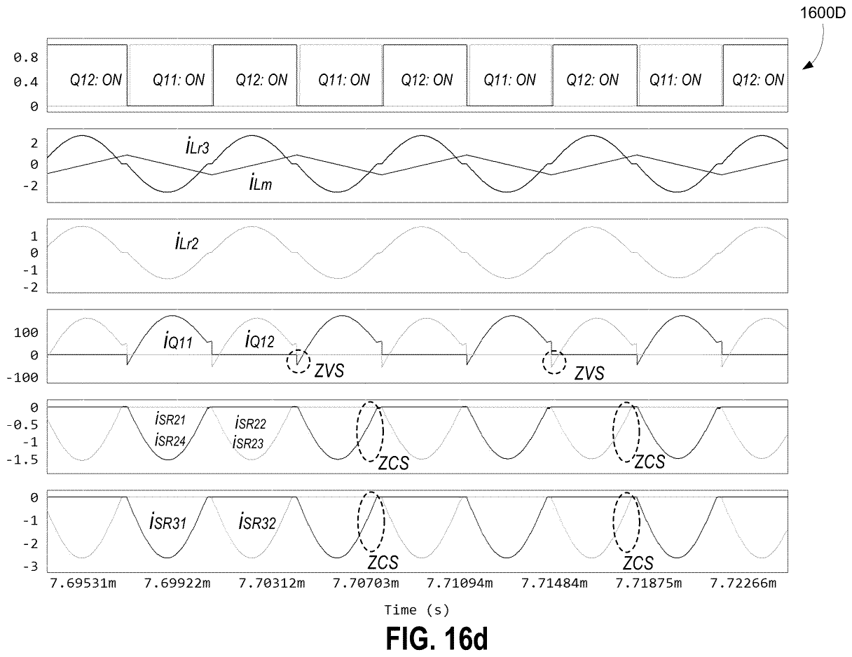

In FIG. 16A-FIG. 16D, power transfer within the three-port converter 106 shown in FIG. 10 according to Mode 5 as shown in FIG. 2E is considered. In Mode 5, Port 1 (i.e., Vdc1) transfers power to Port 3 (i.e., Vdc3) and Port 2 (i.e., Vdc2).

FIG. 16A shows the equivalent circuit 1600A in which the components and load of Port 2 and the source of Port 1 are reflected on the tertiary side of transformer Tr between the tertiary winding Ns2 of transformer Tr and the terminals of Port 3. The components and load of Port 2 and the source of Port 1 are multiplied by their corresponding transformer Tr turn ratio. According to equivalent circuit 1600A in FIG. 16A, the voltage at Port 2 can be calculated as:

$$\frac{N s 2}{N s 1} \times Vdc2\_s = \frac{R e 23}{\vert R e 23 + {( \frac{N s 2}{N s 1} )}^{2} j ( ω L r 2 - \frac{1}{ω Cr 2} ) \vert} \times \frac{N s 2}{N p} \times Vdc1\_s \qquad ( 26 )$$

Substituting Equations (9) and (10) into (26) yields:

$$V d c 2 = \frac{R e 23}{\sqrt{{( R e 23 )}^{2} + {( \frac{N s 2}{N s 1} )}^{4} {( ω L r 2 - \frac{1}{ω Cr 2} )}^{2}}} \times \frac{N s 1}{N p} \times Vdc 1 \qquad ( 27 )$$

where Re23 is the reflected Re2 (equation (14)) on Port 3's side, such that:

$$R e 23 = {( \frac{N s 2}{N s 1} )}^{2} R e 2 \qquad ( 28 )$$

Substituting (28) into (27) yields:

$$V d c 2 = \frac{R e 2}{\sqrt{{( R e 2 )}^{2} + {( ω L r 2 - \frac{1}{ω Cr 2} )}^{2}}} \times \frac{N s 1}{N p} \times Vdc 1 \qquad ( 30 )$$

Notably, Equation (30) is the same as Equation (16), in which Port 1 was feeding only Port 2.

Moreover, the voltage at Port 3 can be calculated as:

$$\begin{matrix}Vdc3\_s = \frac{R e 3}{\vert R e 3 + j ( ω Lr 3 - \frac{1}{ω Cr 3} ) \vert} \times \frac{N s 2}{N p} \times Vdc1\_s \\ = \frac{R e 3}{\sqrt{{( R e 3 )}^{2} + {( ω L r 3 - \frac{1}{ω Cr 3} )}^{2}}} \times \frac{N s 2}{N p} \times Vdc1\_s\end{matrix} \qquad ( 31 )$$

Substituting Equations (9) and (11) into (31) leads to:

$$Vdc 3 = 2 \times \frac{Re 3}{\sqrt{{( Re 3 )}^{2} + {( ω L r 3 - \frac{1}{ω Cr 3} )}^{2}}} \times \frac{Ns 2}{Np} \times Vdc 1 \qquad ( 32 )$$

Notably, Equation (32) is the same as equation (21), where Port 1 was feeding only Port 3.

Equations (30) and (32) are plotted in FIG. 16B, which shows a graphical representation of the voltage for Ports 2 and 3 of a three port converter at various power levels versus switching frequency (Fs), according to some embodiments. In FIG. 16B, the total power is kept constant at 300 W which is equal to the nominal power of Port 1. The delivered power to Port 2 (Pdc2) changes from 25 W to 250 W, and the remaining power goes to Port 3 (Pdc3=300−Pdc2). According to FIG. 16B, Vdc3 remains about constant at various switching frequencies, but the variation in Vdc2 may be significant.

When Port 1 serves as the power source feeding Ports 2 and 3 as loads, the only controllable variable is the switching frequency Fs. A controller may be configured to regulate the voltages of both Ports 2 and 3 using this single control variable. With Vdc2 and Vdc3 varying in the ranges of 20V-24V and 330V-350V, respectively, which may require cross-regulation in order to have acceptable and stable voltage regulation.

According to FIG. 16B, for a switching frequency Fs ranging between 138 kHz and 150 kHz (as indicated by vertical dotted lines), Vdc2 varies from 20V to 24V at 250 W, according to some embodiments. As the load at Port 2 decreases, Vdc2 fluctuation reduces and approaches 24V. Within the same switching frequency range, Vdc3 remains almost constant at 348V regardless of its power. demonstrating excellent cross-regulation between Ports 2 and 3. Consequently, a controller may use feedback from Vdc2 to regulate it using the 138 kHz-150 KHz frequency range, while Vdc3 is unaffected at 348V.

FIG. 16C shows the simulation results 1600C for power transfer from Vdc1 to Vdc2 and Vdc3 (Mode 5), where the delivered power to Port 2 is 250 W (full power) and the delivered power to Port 3 is 50 W, according to some embodiments. The current directions are shown in FIG. 10. The switching frequency is 142 kHz, Vdc2 is regulated at 23V and Vdc3 is regulated at 348V. Q11 and Q12 are operating as the main switches, and SR21, Sr22, SR23, and SR24 at Port 2, and SR31 and SR32 at Port 3, are operating as synchronous rectifiers.

As can be seen in FIG. 16C, the gate signals for switches Q11 and Q12 are shown along with the switch current iQ11 and iQ12 for Port 1. Since the switch currents iQ11 and iQ12 are negative at the turn ON moment (almost −25 A), they are being turned ON at ZVS condition, leading to zero switching losses at the time of turn-on. Also, as switches Q1 and Q2 turn OFF at about 25 A, considering voltage across the switches Q1 and Q2 is 2×3V, the switching loss at the time of turn-off is minimal.

Further, in FIG. 16C, the synchronous rectifier currents iSR21, iSR22, iSR23, iSR24, iSR31 and iSR32 are shown for synchronous rectifiers SR21, SR22, SR23, SR24, SR31 and SR32 of Ports 2 and 3. As can be seen, the synchronous rectifiers SR21, SR22, SR23, SR24 of Port 2, and SR31, SR32 of Port 3 are being turned OFF under ZCS, which eliminates switching losses. Lastly, FIG. 16C shows the magnetizing inductance current iLm, the resonant tank inductor current iLr2 for Port 2, and the resonant tank inductor current iLr3 for Port 3.

FIG. 16D shows the simulation results 1600D for power transfer from Vdc1 to Vdc2 and Vdc3 (Mode 5), where the delivered power to Port 2 is 25 W and the delivered power to Port 3 is 275 W, according to some embodiments. The current directions are shown in FIG. 10. The switching frequency is 142 kHz, Vdc2 is regulated at 24V and Vdc3 is regulated at 348V. Q11 and Q12 are operating as the main switches, and SR21, Sr22, SR23, and SR24 at Port 2, and SR31 and SR32 at Port 3, are operating as synchronous rectifiers.

As can be seen in FIG. 16D, the gate signals for switches Q11 and Q12 are shown along with the switch current iQ11 and iQ12 for Port 1. Since the switch currents iQ11 and iQ12 are negative at the turn ON moment (almost −50 A), the switches Q11 and Q12 are being turned ON at ZVS condition, leading to zero switching losses at the time of turn-on. Also, as switches Q1 and Q2 turn OFF at about 50 A, considering voltage across the switches Q1 and Q2 is 2×3V, the switching loss at the time of turn-off is minimal.

Further, in FIG. 16D, the synchronous rectifier currents iSR21, iSR22, ISR23, iSR24 for Port 2, and iSR31 and iSR32 for Port 3 are shown for synchronous rectifiers SR21, SR22, SR23, SR24 of Port 2 and SR31 SR32 of Port 3. As can be seen, the synchronous rectifiers SR21, SR22, SR23, SR24, SR31 and SR32 are being turned OFF under ZCS, which eliminates switching losses. Lastly, FIG. 16D shows the magnetizing inductance current iLm, the resonant tank inductor current iLr2 for Port 2, and the resonant tank inductor current iLr3 for Port 3.

Therefore, based on the simulation results 1600C and 1600D for power transfer from Vdc1 to Vdc2 and Vdc3 (Mode 5) in the three-port converter 106 under two load conditions (i.e., Port 2 delivered power=250 W/Port 3 delivered power=50 W (FIG. 16C); Port 2 delivered power=25 W/Port 3 delivered power=275 W (FIG. 16D)), the effective voltage regulation and power delivery from Port 1 to Ports 2 and 3 by the converter 106 is validated.

The slight differences between the curves in FIG. 16B and the simulation results in FIGS. 16C and 16D are due to the approximations made during the analysis.

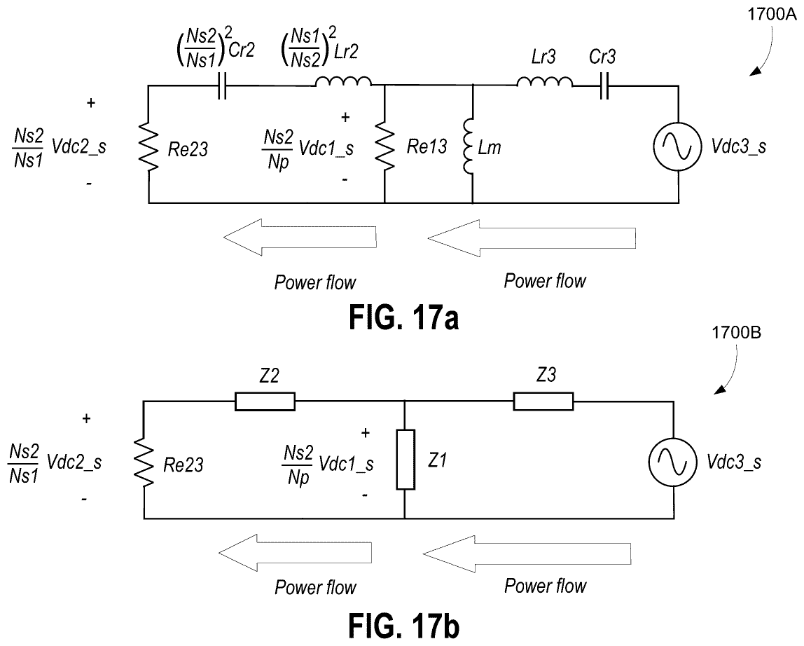

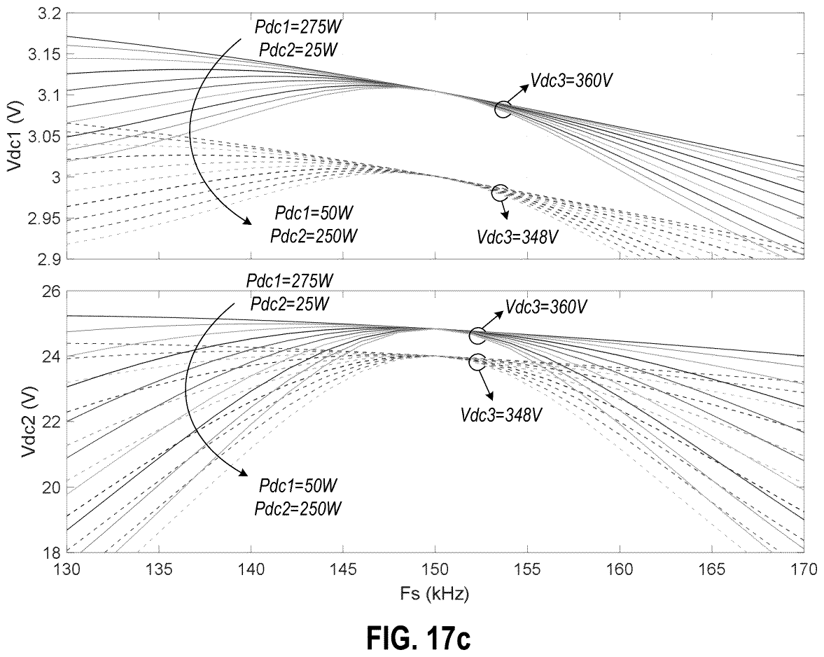

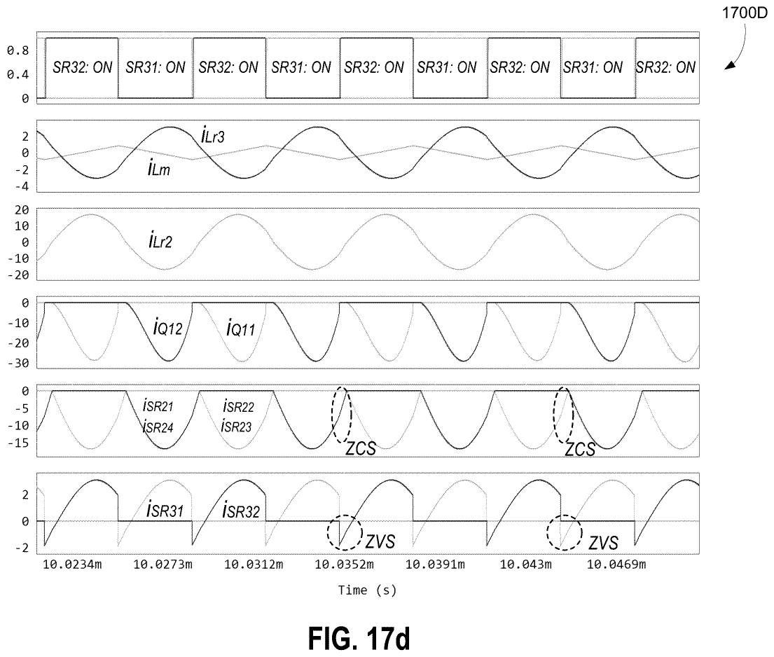

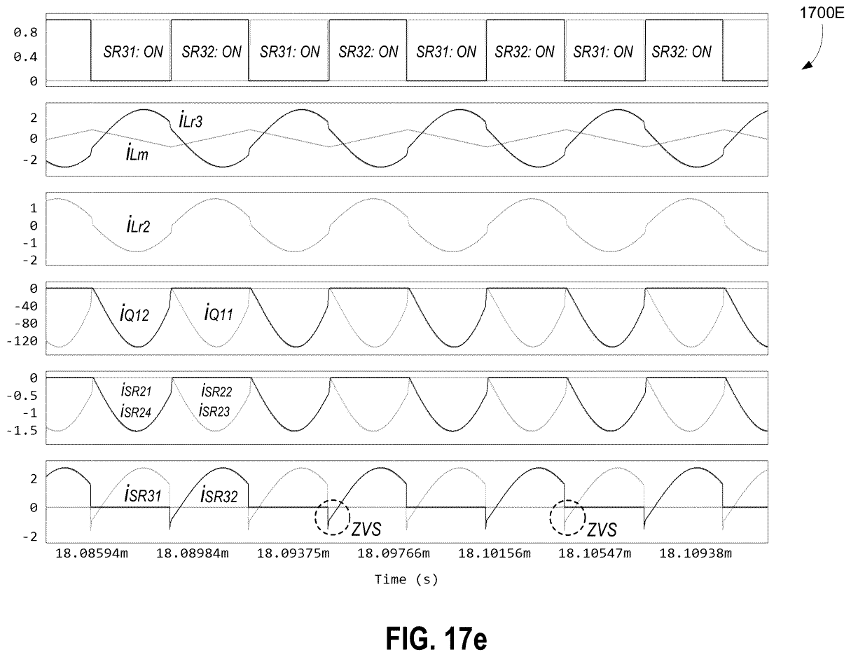

In FIG. 17A-FIG. 17E, the power transfer within the three-port converter according to Mode 6 as shown in FIG. 2F is considered. In this mode, Port 3 (i.e., Vdc3) transfers power to Port 1 (i.e., Vdc1) and Port 2 (i.e., Vdc2). The equivalent circuit 1700A for this mode is shown in FIG. 17A. Here, voltage sources Vdc1 and Vdc2 are replaced by their corresponding FHA resistors reflected to the Port 3 side. To simplify the analysis, the impedances are considered using the equivalent circuit 1700B in FIG. 17B, wherein:

$$Z 1 = j ω Lm \vert \vert Re 13 = \frac{j ω L m \times Re 13}{Re 13 + j ω L m} \qquad ( 33 )$$

$$Z 2 = {( \frac{Ns 2}{Ns 1} )}^{2} ( j ω Lr 2 + \frac{1}{j ω C r 2} ) \qquad ( 34 )$$

$$Z 3 = ( j ω Lr 3 + \frac{1}{j ω C r 3} ) \qquad ( 35 )$$

According to the equivalent circuit 1700B, the voltage at Port 1 (Vdc1) can be calculated as:

$$\frac{Ns 2}{Np} \times Vdc1\_s = \frac{\vert Z 1 \vert \vert ( Z 2 + Re 23 ) \vert}{\vert Z 1 \vert \vert ( Z 2 + Re 23 ) + Z 3 \vert} \times Vdc3\_s \qquad ( 36 )$$

$$V dc1\_s = \frac{Np}{Ns 2} \times \frac{\vert Z 1 ( Z 2 + Re 23 ) \vert}{\vert Z 1 ( Z 2 + Re 23 ) + Z 3 ( Z 1 + Z 2 + Re 23 ) \vert} \times Vdc3\_s \qquad ( 37 )$$

Substituting equations (9) and (11) into equation (37) yields:

$$Vdc 1 = \frac{1}{2} \times \frac{Np}{Ns 2} \times \frac{\vert Z 1 ( Z 2 + Re 23 ) \vert}{\vert Z 1 ( Z 2 + Re 23 ) + Z 3 ( Z 1 + Z 2 + Re 23 ) \vert} \times Vdc 3 \qquad ( 38 )$$

The voltage at Port 2 (Vdc2) can then be calculated as:

$$\frac{Ns 2}{Ns 1} \times Vdc2\_s = \frac{\vert Re 23 \vert}{\vert Z 2 + Re 23 \vert} \times \frac{Ns 2}{Np} \times Vdc1\_s \qquad ( 39 )$$

Substituting equation (37) into equation (39) yields:

$$Vdc2\_s = \frac{Ns 1}{Ns 2} \times \frac{\vert Re 23 \vert}{\vert Z 2 + Re 23 \vert} \times \frac{\vert Z 1 ( Z 2 + Re 23 ) \vert}{\vert Z 1 ( Z 2 + Re 23 ) + Z 3 ( Z 1 + Z 2 + Re 23 ) \vert} \times Vdc3\_s \qquad ( 40 )$$

Substituting equations (9) and (10) into equation (40) results in:

$$Vdc 2 = \frac{1}{2} \times \frac{Ns 1}{Ns 2} \times \frac{\vert Re 23 \vert}{\vert Z 2 + Re 23 \vert} \times \frac{\vert Z 1 ( Z 2 + Re 23 ) \vert}{\vert Z 1 ( Z 2 + Re 23 ) + Z 3 ( Z 1 + Z 2 + Re 23 ) \vert} \times Vdc 3 \qquad ( 41 )$$

Equations (38) and (41) are plotted in FIG. 17C using the component specifications provided in Table 1. As shown in FIG. 17C, the total power is kept constant at 300 W which is equal to the nominal power of Port 3. The delivered power to Port 2 (Pdc2) changes from 25 W to 250 W, and the remaining power goes to Port 1 (Pdc1=300 W-Pdc2).

When Port 3 serves as the power source supplying Ports 1 and 2 as loads, since Vdc3 is variable (e.g., the connected inverter to Port 3 can regulate Vdc3), there can be two control variables, namely the switching frequency and Vdc3. A controller can use these two variables to independently regulate Vdc2 and the current being injected into the ESS battery (i.e., at Vdc1). Therefore, two sets of curves are plotted in FIG. 17C for Vdc1 and Vdc2.

For Vdc1, the dashed-line curves in FIG. 17C illustrate how Vdc1 varies with the switching frequency when Vdc3 is set to 348V. Similarly, the solid-line curves in FIG. 17C represent the response of Vdc1 to the switching frequency when Vdc3 is set to 360V. It can be observed that as Vdc3 increases, Vdc1 also increases. Consequently, Vdc1 can be controlled using both the switching frequency and the voltage at Port 3 (Vdc3).

In the same way, for Vdc2, the dashed-line curves in FIG. 17C illustrate how Vdc2 varies with the switching frequency when Vdc3 is set to 348V. Similarly, the solid-line curves in FIG. 17C represent the response of Vdc2 to the switching frequency when Vdc3 is set to 360V. It can be observed that as Vdc3 increases, Vdc2 also increases. Consequently, Vdc2 can be controlled using both the switching frequency and the voltage at Port 3 (Vdc3).

According to FIG. 17C, when the switching frequency is lower than the resonant frequency, Vdc1 decreases at low power but increases at high power. Conversely, when the switching frequency is higher than the resonant frequency, Vdc1 consistently decreases as the frequency increases. Therefore, controlling Vdc1 at frequencies above resonance is easier, as a controller can simply increase the frequency to reduce Vdc1 or decrease the frequency to raise Vdc1, regardless of the power level. However, at frequencies below resonance, decreasing the frequency may cause Vdc1 to either increase or decrease, depending on the power level, making the control scheme more complex. Notably, Vdc2 exhibits similar behavior in response to variations in the switching frequency.

Therefore, in Mode 6, the switching frequency is set to change from 150 kHz to 170 kHz (slightly higher than resonant frequency) and Vdc3 is changing from 355V to 360V. With these two variables, Vdc2 and the current at Port 1 (i.e., the battery current) are independently regulated.

FIG. 17D shows the simulation results for power transfer from Vdc3 to Vdc1 and Vdc2, where the delivered power at Port 2 is 250 W (full power) and the delivered power at Port 1 is 50 W, according to some embodiments. The current directions are shown in FIG. 10. The switching frequency is 157 kHz (slightly over resonant frequency), Vdc3 is set to 355V, and Vdc2 is regulated at 22.5V. Since Vdc1 is fixed at 3V, in order to manage its power, the injected current to Vsc1 has to be controlled. In this simulation, the average current going to the ESS battery (Vdc1) is 16.7 A. Switches SR31 and SR32 are operating as the main switches, and Q11 and Q12 at Port 1, and SR21, Sr22, SR23, and SR24 at Port 2 are operating as synchronous rectifiers.

As can be seen in FIG. 17D, the gate signals for switches SR31 and SR32 are shown along with the switch currents iSR31, iSR32 for Port 3. Since the switch currents iSR31 and iSR32 are negative at the turn ON moment (almost −2 A), they are being turned ON at ZVS condition, leading to zero switching losses at the time of turn-on. Also, as switches iSR31 and iSR32 turn OFF at a very low current (about −5A), considering the low voltage across the switches (i.e., 2×3V), the switching loss at the time of turn-off is minimal.

Further, in FIG. 17D, the synchronous rectifier currents iSR21, iSR22, iSR23, iSR24 for switches SR21, SR22, SR23, SR24 of Port 2 are shown. As can be seen, the synchronous rectifiers SR21, SR22, SR23, and SR24 are being turned OFF under ZCS, which eliminates switching losses.

Further, the synchronous rectifier currents iQ11, iQ12 for switches Q11, Q12 at Port 1 are shown. As can be seen, the switches Q11, Q12 are being turned OFF at a very low current (−5 A). As the voltage across the switches Q11 and Q12 is low (i.e., 2×3V), the switching losses at turn-off for switches Q11 and Q12 will be very small.

Lastly, FIG. 17D shows the magnetizing inductance current iLm, the resonant tank inductor current iLr2 for Port 2, and the resonant tank inductor current iLr3 for Port 3.

FIG. 17E shows the simulation results 1700E for power transfer from Vdc3 to Vdc1 and Vdc2 (Mode 5), where the delivered power at Port 2 is 25 W (10% of full power) and the delivered power at Port 1 is 275 W. The current directions are shown in FIG. 10. The switching frequency is 163 kHz (slightly over resonant frequency), Vdc3 is set to 360V, and Vdc2 is regulated at 24V. Since Vdc1 is fixed at 3V, in order to manage its power, the injected current to Port 1 may be controlled. In simulation 1700E, the average current going to the ESS battery (Vdc1) is 91.7 A, SR31 and SR32 operate as the main switches, and Q11 and Q12 at Port 1, and SR21, Sr22, SR23, and SR24 at Port 2, are operating as synchronous rectifiers.

As can be seen in FIG. 17E, the gate signals for switches SR31 and SR32 are shown along with the switch currents iSR31, iSR32 for Port 3. Since the switch currents iSR31 and iSR32 are negative at the turn ON moment (almost −1 A), they are being turned ON at ZVS condition, leading to zero switching losses at the time of turn-on.

Further, in FIG. 17E, the synchronous rectifier currents iSR21, iSR22, iSR23, and iSR24, are shown for synchronous rectifiers SR21, SR22, SR23, and SR24, of Port 2. As can be seen, the synchronous rectifiers SR21, SR22, SR23, and SR24 are being turned OFF under ZCS, which eliminates switching losses at turn-off time. Also, while the voltage across switches SR21, SR22, SR23, and SR24 is about 24V, since the current at the time of turn-off is very low (about −0.5 A) for SR21, SR22, SR23, and SR24, the switching loss at the time of turn-off is minimal.

In FIG. 17E, the synchronous rectifier currents iQ11, iQ12 for switches Q11, Q12 of Port 1 are shown. As can be seen, the synchronous rectifiers Q11, Q12 are being turned OFF under ZCS, which eliminates switching losses at turn-off time.

Lastly, FIG. 17E shows the magnetizing inductance current iLm, the resonant tank inductor current iLr2 for Port 2, and the resonant tank inductor current iLr3 for Port 3.

Therefore, based on the simulation results shown in 1700D and 1700E for power transfer from Vdc3 to Vdc1 and Vdc2 (Mode 6) in the three-port converter 106 under two load conditions (Port 2 delivered power=250 W/Port 1 delivered power=50 W (FIG. 17D); Port 2 delivered power=25 W/Port 1 delivered power=275 W (FIG. 17E)), the effective voltage regulation and power delivery from Port 3 to Ports 1 and 2 by the converter 106 is validated.

The slight differences between the curves in FIG. 17C and the simulation results in FIGS. 17D and 17E are due to the approximations made during the analysis.

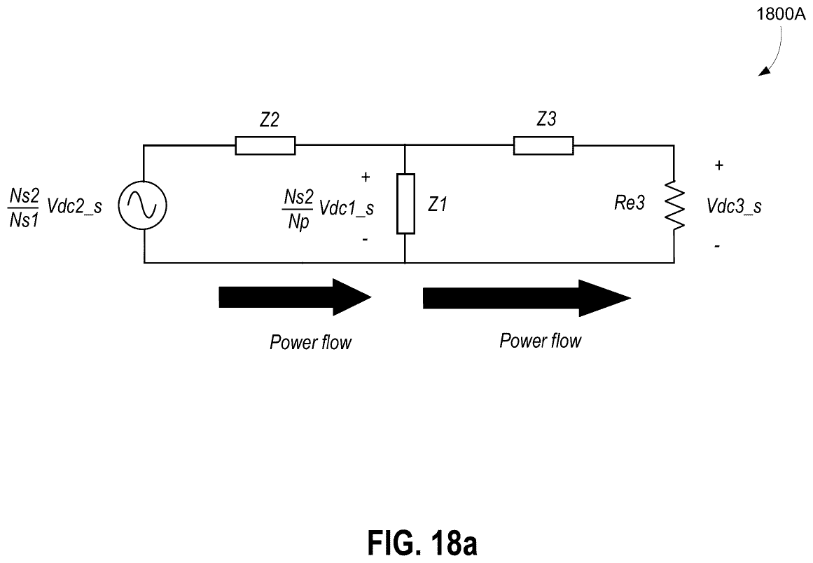

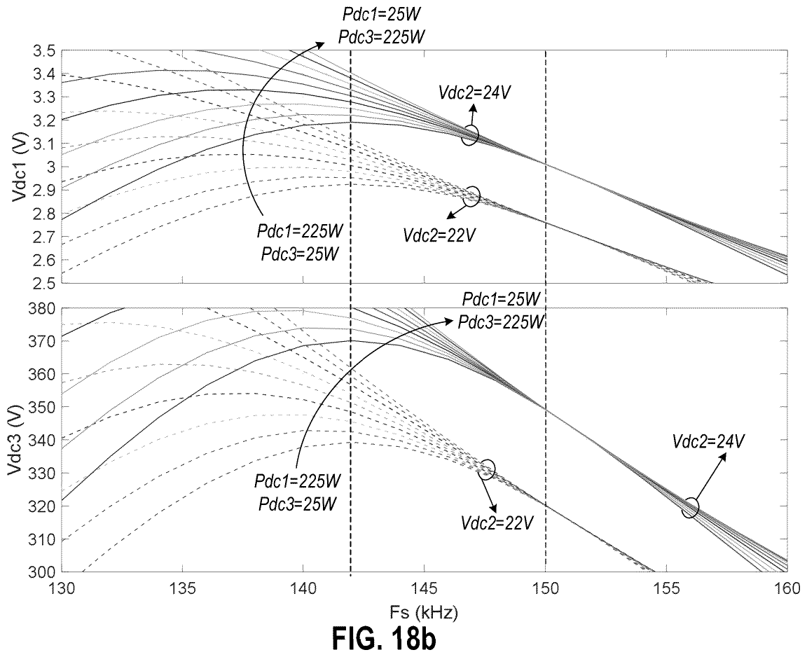

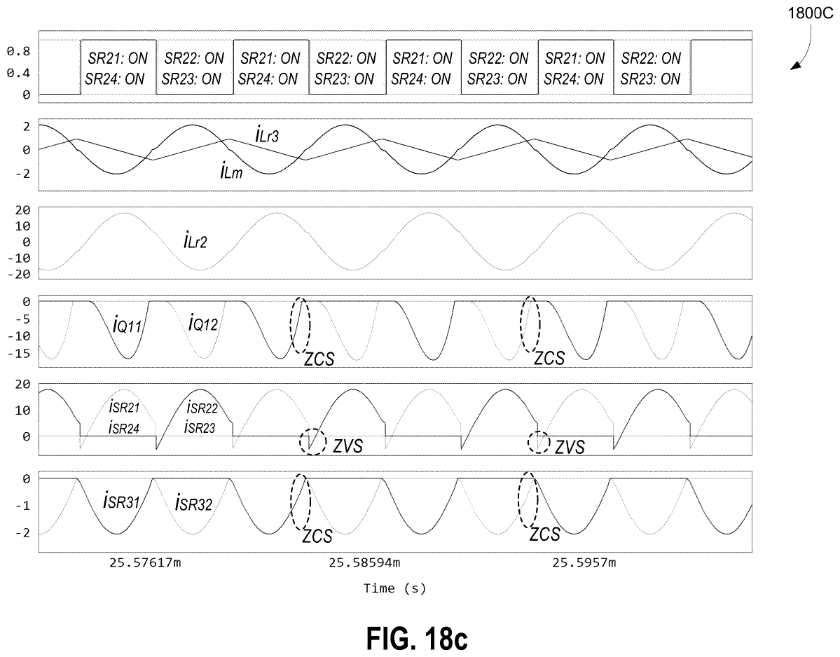

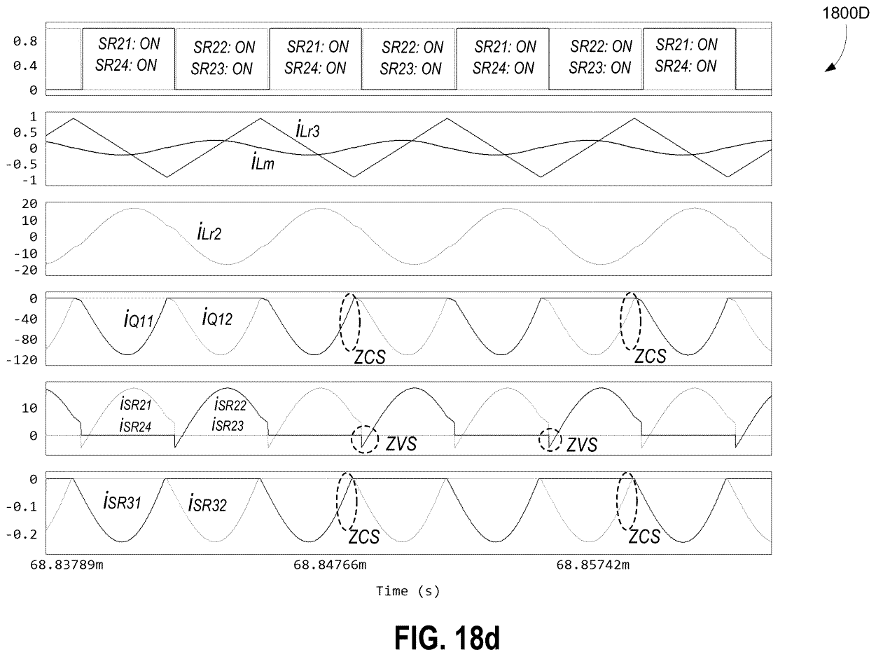

In FIG. 18A-FIG. 18D, the power transfer within the three-port converter 106 shown in FIG. 10 according to Mode 7 as shown in FIG. 2G is considered. In mode 7, Port 2 feeds Port 1 and Port 3. The equivalent circuit 1800A for this mode is shown in FIG. 18A. Here, voltage sources Vdc1 and Vdc3 are replaced by their corresponding FHA resistors reflected on the Port 3 side. To simplify the analysis, the impedances introduced in equations (33), (34), and (35) are being used here due to similarities in configurations.

Accordingly, the voltage at Port 1 (Vdc1) can be calculated as:

$$\frac{Ns 2}{Np} \times Vdc1\_s = \frac{Ns 2}{Ns 1} \times \frac{\vert Z 1 \vert \vert ( Z 3 + Re 3 ) \vert}{\vert Z 1 \vert \vert ( Z 3 + Re 3 ) + Z 2 \vert} \times Vdc2\_s \qquad ( 42 )$$

$$Vdc1\_s = \frac{Np}{Ns 1} \times \frac{\vert Z 1 ( Z 3 + Re 3 ) \vert}{\vert Z 1 ( Z 3 + Re 3 ) + Z 2 ( Z 1 + Z 3 + Re 3 ) \vert} \times Vdc2\_s \qquad ( 43 )$$

Substituting equations (9) and (10) into equation (43) yields:

$$Vdc 1 = \frac{Np}{Ns 1} \times \frac{\vert Z 1 ( Z 3 + Re 3 ) \vert}{\vert Z 1 ( Z 3 + Re 3 ) + Z 2 ( Z 1 + Z 3 + Re 3 ) \vert} \times Vdc 2 \qquad ( 44 )$$

The voltage at Port 3 (Vdc3) can then be calculated as:

$$Vdc3\_s = \frac{\vert Re 3 \vert}{\vert Z 3 + Re 3 \vert} \times \frac{Ns 2}{Np} \times Vdc1\_s \qquad ( 45 )$$

Substituting Equation (43) into equation (45) yields:

$$Vdc3\_s = \frac{\vert Re 3 \vert}{\vert Z 3 + Re 3 \vert} \times \frac{Ns 2}{Np} \times \frac{Np}{Ns 1} \times \frac{\vert Z 1 ( Z 3 + Re 3 ) \vert}{\vert Z 1 ( Z 3 + Re 3 ) + Z 2 ( Z 1 + Z 3 + Re 3 ) \vert} \times Vdc2\_s \qquad ( 46 )$$

Substituting equations (10) and (11) into equation (46) results in:

$$Vdc 3 = 2 \times \frac{Ns 2}{Ns 1} \times \frac{\vert Re 3 \vert}{\vert Z 3 + Re 3 \vert} \times \frac{\vert Z 1 ( Z 3 + Re 3 ) \vert}{\vert Z 1 ( Z 3 + Re 3 ) + Z 2 ( Z 1 + Z 3 + Re 3 ) \vert} \times Vdc 2 \qquad ( 47 )$$

Equations (44) and (47) are plotted in FIG. 18B using the component specifications provided in Table 1. As shown in FIG. 18B, the total power is kept constant at 250 W which is equal to the nominal power of Port 2. The delivered power to Port 3 (Pdc3) changes from 25 W to 250 W, and the remaining power goes to Port 1 (Pdc1=300-Pdc3), according to some embodiments.

When Port 2 serves as the power source while Ports 1 and 3 act as loads, since Vdc2 is variable (e.g., the connected regulator to Port 2 can regulate Vdc2) there can be two control variables, namely the switching frequency and Vdc2. A controller can use these two variables to independently regulate Vdc3 and the current being injected into the ESS battery (at Vdc1). Therefore, two sets of curves are plotted in FIG. 18C for Vdc1 and Vdc3.

For Vdc1, the dashed-line curves in FIG. 18B illustrate how Vdc1 varies with the switching frequency when Vdc2 is set to 22V. Similarly, the solid-line curves in FIG. 18B represent the response of Vdc1 to the switching frequency when Vdc2 is set to 24V. It can be observed that as Vdc2 increases, Vdc1 also increases. Consequently, Vdc1 can be controlled using both the switching frequency and the voltage at Port 2 (Vdc2).

In the same way, for Vdc3, the dashed-line curves in FIG. 18B illustrate how Vdc3 varies with the switching frequency when Vdc2 is set to 22V. Similarly, the solid-line curves in FIG. 18B represent the response of Vdc3 to the switching frequency when Vdc2 is set to 24V. It can be observed that as Vdc2 increases, Vdc3 also increases. Consequently, Vdc3 can be controlled using both the switching frequency and the voltage at Port 2 (Vdc2).

According to FIG. 18B, as the switching frequency becomes higher than 142 kHz, Vdc1 and Vdc3 continuously decrease. Therefore, keeping the switching frequency around the resonant frequency (150 kHz) is sufficient to effectively control the power flow to Port 2 and Port 3.

Therefore, in Mode 7, the switching frequency Fs is set to change from 142 kHz to 150 kHz, and Vdc2 is changing from 22V to 24V. With these two variables, Vdc3 and the battery current at Port 1 are independently regulated.

FIG. 18C shows the simulation results 1800C for power transfer from Vdc2 to Vdc1 and Vdc3 (Mode 7), where the output power at Port 3 is 225 W and the output power at Port 1 is 25 W, according to some embodiments. The current directions are shown in FIG. 10. The switching frequency is 147 kHz, Vdc2 is set to 23V, and Vdc3 is regulated at 347V. Since Vdc1 is fixed at 3V, in order to manage its power, the injected current has to be controlled. In this simulation, the average current going to the ESS battery (Vdc1) is 8.3 A, SR21, Sr22, SR23, and SR24 are operating as the main switches, and Q11 and Q12 at Port 1, and SR31 and SR32 at Port 3 are operating as synchronous rectifiers.

As can be seen in FIG. 18C, the gate signals for switches SR21, SR22, SR23, and SR24 are shown for the switches SR21, Sr22, SR23, and SR24 of Port 2. Since the switch currents iSR21, iSr22, iSR23, and iSR24 are negative at the turn ON moment (almost −5 A), they are being turned ON at ZVS condition, leading to zero switching losses at the time of turn-on. Also, as switches SR21, SR22, SR23, and SR24 turn OFF at about 5 A, considering that the voltage across the switches SR21, SR22, SR23, and SR24 is about 23V, the switching loss at the time of turn-off is minimal for switches SR21, SR22, SR23, and SR24.

Further, in FIG. 18C, the synchronous rectifier currents iQ11 and iQ12 for Port 1 and iSR31 and iSR32 for Port 3 are shown. As can be seen, the synchronous rectifiers SR31 and SR32 are being turned off under ZCS, which eliminates switching losses for SR31 and SR32 at turn off. Additionally, switches Q11 and Q12 are also being turned OFF under ZCS, which eliminates switching loss.

Lastly, FIG. 18C shows the magnetizing inductance current iLm, the resonant tank inductor current iLr2 for Port 2, and the resonant tank inductor current iLr3 for Port 3.

FIG. 18D shows the simulation results 1800D for power transfer from Vdc2 to Vdc1 and Vdc3 (Mode 7), where the delivered power to Port 3 is 25 W and the delivered power to Port 1 is 225 W, according to some embodiments. The current directions are shown in FIG. 10. The switching frequency is 144 kHz, Vdc2 is set to 22V, and Vdc3 is regulated at 350V. Since Vdc1 is fixed at 3V, in order to manage its power, the injected current to the ESS battery at Vdc1 may be controlled. In simulation 1800D, the average current going to the ESS battery (Vdc1) is 75 A, SR21, Sr22, SR23, and SR24 are operating as the main switches, and Q11 and Q12 at Port 1, and SR31 and SR32 at Port 3 are operating as synchronous rectifiers.

As can be seen in FIG. 18D, the gate signals for switches SR21, Sr22, SR23, and SR24 are shown. Since the switch currents iSR21, iSr22, iSR23, and iSR24 for switches SR21, Sr22, SR23, and SR24 are negative at the turn ON moment (almost −5 A), the switches SR21, Sr22, SR23, and SR24 are being turned ON at ZVS condition, leading to zero switching losses at the time of turn-on. Also, while the voltage across the switches SR21, Sr22, SR23, and SR24 is about 23V at turn off, since the current is about 5 A, the switching loss at the time of turn-off is minimal.

Further, in FIG. 18D, the synchronous rectifier currents iQ11 and iQ12 for Port 1 and synchronous rectifier currents iSR31 and iSR32 for Port 3 are shown. As can be seen, the synchronous rectifiers SR31 and SR32 are being turned OFF under ZCS, which eliminates switching losses. Additionally, Switches Q11 and iQ12 are also being turned OFF under ZCS, which eliminates switching loss.

Lastly, FIG. 18D shows the magnetizing inductance current iLm, the resonant tank inductor current iLr2 for Port 2, and the resonant tank inductor current iLr3 for Port 3.

Therefore, based on the simulation results 1800C and 1800D for power transfer from Vdc2 to Vdc1 and Vdc3 (Mode 7) in the three-port converter 106 under two load conditions (Port 3 delivered power=225 W/Port 1 delivered power=25 W (FIG. 18C); Port 3 delivered power=25 W/Port 1 delivered power=225 W (FIG. 18D)), the effective voltage regulation and power delivery from Port 2 to Ports 1 and 3 by the converter 106 is validated.

The slight differences between the curves in FIG. 18B and the simulation results in FIGS. 18C and 18D are due to the approximations made during the analysis.

The simulation results discussed above in FIGS. 12A-18D for each control mode are summarized in the following Tables 2-8. In Tables 2-8, negative power/current means the corresponding port is acting as a source, and positive power/current means it is acting as load.

TABLE 2
Simulations results summary for Mode 1: Power delivery from Port 1 to Port 2

| | Light Load (10% of Full load) | | | | Full Load | | | |
|---|---|---|---|---|---|---|---|---|
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | −25 | −8.33 | 138k | 3 | −250 | −83.33 | 142k |
| Vdc2 | 24 | +25 | +1.14 | | 22 | +250 | +11.36 | |
| Vdc3 | — | 0 | — | | — | 0 | — | |

TABLE 3
Simulations results summary for Mode 2: Power delivery from Port 2 to Port 1

| | Light Load (10% of Full load) | | | | Full Load | | | |
|---|---|---|---|---|---|---|---|---|
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | +25 | +8.33 | 145k | 3 | +250 | +83.33 | 144k |
| Vdc2 | 24 | −25 | −10.42 | | 24 | −250 | −10.42 | |
| Vdc3 | — | 0 | — | | — | 0 | — | |

TABLE 4
Simulations results summary for Mode 3: Power delivery from Port 1 to Port 3

| | Light Load (10% of Full load) | | | | Full Load | | | |
|---|---|---|---|---|---|---|---|---|
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | −30 | −10 | 140k | 3 | −300 | −100 | 140k |
| Vdc2 | — | 0 | — | | — | 0 | — | |
| Vdc3 | 348 | +30 | +0.086 | | 347 | +300 | +0.86 | |

TABLE 5
Simulations results summary for Mode 4: Power delivery from Port 3 to Port 1

| | Light Load (10% of Full load) | | | | Full Load | | | |
|---|---|---|---|---|---|---|---|---|
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | +30 | +10 | 121k | 3 | +300 | +100 | 121k |
| Vdc2 | — | 0 | — | | — | 0 | — | |
| Vdc3 | 330 | −30 | −0.09 | | 330 | −300 | −0.91 | |

TABLE 6
Simulations results summary for Mode 5: Power
delivery from Port 1 to Port 2 and Port 3

| | Light Load at Port 2 | | | | Full Load at Port 2 | | | |
|---|---|---|---|---|---|---|---|---|
| | Full Load at Port 3 | | | | Light Load at Port 3 | | | |
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | −300 | −100 | 142k | 3 | −300 | −100 | 142k |
| Vdc2 | 24 | +25 | +1 | | 23 | +250 | +10.87 | |
| Vdc3 | 348 | +275 | +0.79 | | 348 | +50 | +0.14 | |

TABLE 7
Simulations results summary for Mode 6: Power
delivery from Port 3 to Port 1 and Port 2

| | Light Load at Port 2 | | | | Full Load at Port 2 | | | |
|---|---|---|---|---|---|---|---|---|
| | Full Load at Port 1 | | | | Light Load at Port 1 | | | |
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | +275 | +91.7 | 163k | 3 | +50 | +16.7 | 157k |
| Vdc2 | 24 | +25 | +1 | | 22.5 | +250 | +11.1 | |
| Vdc3 | 360 | −300 | −0.83 | | 355 | −300 | −0.85 | |

TABLE 8
Simulations results summary for Mode 7: Power
delivery from Port 2 to Port 1 and Port 3

| | Light Load at Port 3 | | | | Full Load at Port 3 | | | |
|---|---|---|---|---|---|---|---|---|
| | Full Load at Port 1 | | | | Light Load at Port 1 | | | |
| | | | | Switching | | | | Switching |
| | Voltage | Power | Current | Frequency | Voltage | Power | Current | Frequency |
| | (V) | (W) | (A) | (Hz) | (V) | (W) | (A) | (Hz) |
| Vdc1 | 3 | +225 | +83.3 | 144k | 3 | +25 | +8.3 | 147k |
| Vdc2 | 22 | −250 | −11.4 | | 23 | −250 | −10.9 | |
| Vdc3 | 350 | +25 | +0.07 | | 347 | +225 | +0.65 | |

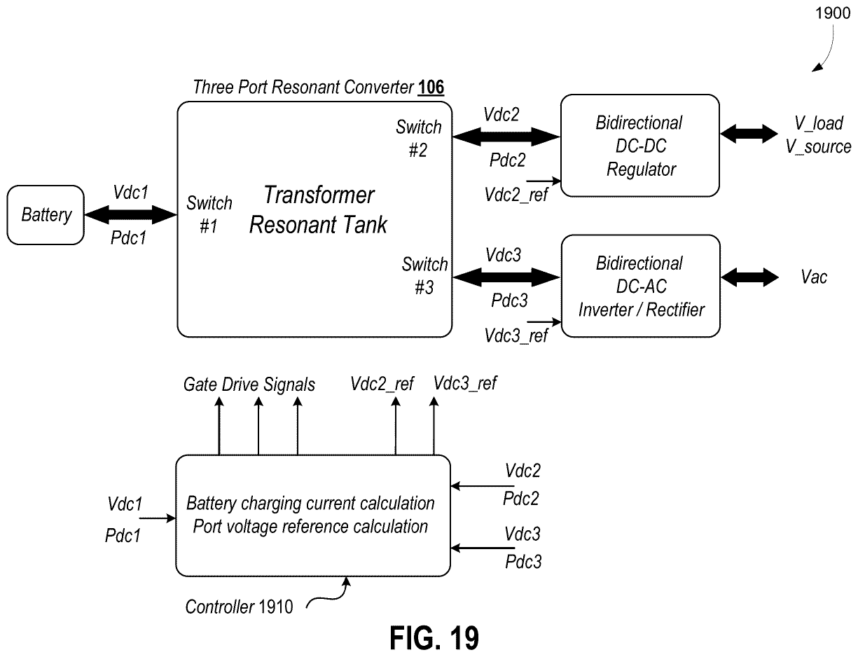

In FIG. 19, a control diagram is shown for controlling the three-port LLC converter 106 shown in FIG. 10, according to some embodiments. In FIG. 19, the maximum output power of converter 106 is assumed to be Pmax=300 W. Based on this assumption, three scenarios are considered:
Scenario #1: Port 1, which is connected to a discharging ESS battery, is transferring power to Port 2 (Vdc2, low DC voltage load) and/or Port 3 (Vdc3, high DC voltage load). In this scenario, the ESS battery voltage (V_bat) can vary between V_bat_min to V_bat_max. When the ESS battery is fully charged, the battery voltage is the highest (i.e., Vdc1=V_bat_max), and when the ESS battery is almost depleted, the battery voltage is lowest (i.e., Vdc1=V_bat_min).
Scenario #2: Port 3, which is connected to an AC grid through an inverter, is acting as a power source to charge the ESS battery at Port 1 (Vdc1) and to charge the low DC voltage load at Port 2 (Vdc2).
Scenario #3: Port 2, which is connected to a solar cell, is acting as a power source to charge the ESS battery at Port 1 (Vdc1) and to provide power to high DC voltage load at Port 3 (Vdc3) so that it can provide an AC output.

According to Scenario #1, the switching frequency of a three-port LLC converter 106 as shown in FIG. 10 is set to be equal to or very close to the resonant frequency, Fs=Fr. In this case, Vdc2 and Vdc3 will be proportional to Vdc1 (i.e., ESS battery voltage V_bat). The switches Q11 and Q12 at Port 1 may act as control switches (active switch) and the four switches SR21, SR22, SR23, SR24 at Port 2 (Vdc2) and the two switches SR31, SR32 at Port 3 (Vdc3) may act as synchronous rectifiers. When the ESS battery voltage V_bat is at a minimum V_bat_min, Vdc2 and Vdc3 will also be at a minimum; Vdc2_min, Vdc3_min. When the ESS battery voltage V_bat is at maximum V_bat_max, Vdc2 and Vdc3 will also be at a maximum, Vdc2_max, Vdc3_max.

As discussed above at FIG. 10, the AC voltage (Vdc3) is regulated by the inverter that is connected to Port 3. The DC-DC regulator at Port 2 will regulate the DC voltage at Vdc2 to a fixed voltage required by the low DC voltage load. Therefore, although Vdc2 and Vdc3 will vary as the ESS battery voltage V_bat varies, the voltages that are supplied by Port 3 to the high DC voltage load and by Port 2 to the low DC voltage load can be controlled using the AC inverter and DC-DC regulator, respectively.

Further, power limits may be imposed on the total power delivered to one or both of Vdc2 and Vdc3 by Port 1. For example, when the total delivered power from one or both of Vdc2 (Port 2) and Vdc3 (Port 3) exceeds 300 W (i.e., the maximum power limit), either the power delivered to Port 2 (Pdc2) and/or Port 3 (Pdc3) will be reduced. The maximum power limit may be determined based on the application of the converter 106 and the component ratings.

According to Scenario #2, the AC grid (coupled through Port 3) is used to either charge the ESS battery (Vdc1) at Port 1 and/or provide power to the low DC voltage load (Vdc2) at Port 2. The switching frequency of converter 106 is set to be about equal to the resonant frequency of converter 106 (i.e., Fs=Fr). The two switches SR31, SR32 at Port 3 (Vdc3) act as the control switches. The four switches SR21, SR22, SR23, SR24 at Port 2 and two switches Q11, Q12 at Port 1 operate as synchronous rectifiers (e.g., SR FET).

The power Pdc2 delivered to Port 2 is measured and the delta between the maximum power (i.e., Pmax=300 W) and Pdc2 determines the power which may be delivered to the ESS battery at Port 1 (Pdc1):

$$Pdc 1 = Pmax - Pdc 2 \qquad ( 48 )$$

The ESS battery current (i_bat) at Port 1 may be expressed as:

$$i\_bat3 = Pdc 1 / Vdc 1 \qquad ( 49 )$$

It is noted that the ESS battery voltage (V_bat) at Port 1 may be slightly below Vdc1 because of parasitic impedances (such as transformer leakage impedance, switch resistance, battery pack impedance, track resistance, as discussed above).

The voltage level at Port 3 (i.e., Vdc3) may be controlled by the inverter (as shown in FIG. 10) which may operate in rectifier mode during Scenario #2, so that the battery charging current is controlled to adhere to the i_bat3 value calculated by equation (49). The battery voltage V_bat at Port 1 and therefore, the ESS battery voltage Vdc1 at Port 1 will change as the ESS battery current (i_bat) varies. The voltage at Port 3, Vdc3, may also vary to maintain the desired battery charging current, I_bat3, which is calculated continuously based on Pdc1 and Vdc1 from equations (48) and (49). Since Vdc3 may vary based on variance in the battery voltage, V_bat and voltage at Port 1 (Vdc1), the voltage at Port 2 (Vdc2) will also change accordingly when power is being transferred to both Port 1 and Port 2 simultaneously.

In an example operating condition, the output power of Port 2 is Pdc21=100 W, and 200 W (300 W-100 W) is used to charge the battery. It is assumed that initially, the battery voltage is around V_bat1=2.8V. Therefore, the battery charging current i_Bat is calculated as i_Bat1=200 W/2.8V=71.4 A. The controller 1910 produces a reference voltage, Vdc3_ref1, for bidirectional DC-AC inverter/rectifier (which is operating in rectifier mode) so that the output voltage of the DC-AC inverter is Vdc31=Vdc3_ref1 and the actual battery charging current is at i_Bat1=71.4 A.

When the battery is charged for a period of time, its voltage will increase. Assuming the actual battery voltage increases to V_bat2=3.2V, and Port 2 still receives Pdc21=100 W, then the battery charging current can then be calculated as i_Bat2=200 W/3.2V=62.5 A. In this case, the controller 1910 produces another reference voltage, Vdc3_ref2, for bidirectional DC-AC inverter/rectifier (which is operating in rectifier mode) so that the output voltage of the DC-AC inverter is Vdc32=Vdc3_ref2 and the actual battery charging current is regulated at i_Bat2=62.5 A.

If at a particular time n, Port2 receives power Pdc2n and battery voltage is at V_batn, the battery charging current is calculated as i_Batn=(Pmax−Pdc2n)/V_batn. The controller 1910 will then produce the reference voltage, Vdc3_refn, for DC-AC inverter/rectifier (which operates as a rectifier) so that the battery charging current is regulated at i_Batn. For example, if Pdc2n=150 W, V_Batn=3V, i_Batn is calculated as i_Batn=(300 W −150 W)/3V=50 A. The controller will generate a reference voltage Vdc3_refn for DC-AC inverter/rectifier to control the actual battery charging to 50A.

Based on the above examples, it is required that the controller 1910 needs to monitor (sense) the output power at Port 2, Pdc2, and the battery voltage V_bat, (which is represented by Vdc1, as Vdc1 and V_bat are every close to each other), to calculate the battery charging current. The controller 1910 then generates the reference voltage Vdc3_ref to DC-AC inverter/rectifier to ensure the desired battery charging current.

According to Scenario #3 associated with FIG. 19, a solar cell coupled to Port 2 may be used to charge the ESS battery at Port 1 and to provide an input to the inverter at Port 3. The four switches SR21, SR22, SR23, SR24 at Port 2 (Vdc2) act as the control switches for converter 106, and the two switches Q11, Q12 at Port 1 (Vdc1) and two switches SR31, SR32 at Port 3 (Vdc3) act as synchronous rectifiers (e.g., SR FET). The switching frequency of converter 106 is set to be about equal to the resonant frequency of converter 106 (i.e., Fs=Fr).

The power delivered to Vdc3 (i.e., Pdc3, which is the same as the AC output power from the inverter at Port 3), is measured continuously and the delta between the maximum power (i.e., Pmax=300 W) and Pdc3 determines the power which may be delivered to the ESS battery at Port 1 (Pdc1):

$$Pdc 1 = Pm ax - Pdc 3 ; I\_bat2 = Pdc 1 / Vdc 1 \qquad ( 50 )$$

Therefore, as the ESS battery voltage (V_bat) at Port 1 changes between V_bat_min to V_bat_max (i.e., based on the state of the charge), the voltage Vdc1 at Port 1 will change. I_bat2 will be calculated and controlled continuously, similar to the method disclosed under Scenario #2 above.

The voltage Vdc2 at Port 2 may be controlled by the DC-DC regulator (as shown in FIG. 10) that is coupled to Port 2, so that the battery charging current (I_bat2) is controlled to be about equal to the ideal I_bat2 value calculated by equation (50). As the battery voltage, V_bat, and therefore the voltage Vdc1 at Port 1 varies, the voltage Vdc2 at Port 2 will also vary in order to maintain the desired battery charging current, I_bat2, which is calculated continuously based on Pdc1 and Vdc1 from equation (50).

Therefore, in some embodiments, a three-port resonant converter 106 may be connected to a battery (Port 1), a bidirectional DC-DC regulator (Port 2), and to a bidirectional DC-AC inverter (rectifier) (Port 3). The three-port resonant converter 106 may consist of three switching networks, at least one transformer Tr with multiple primary and secondary side windings, and at least two resonant tanks each coupled to one of Port 2 and Port 3. In the example of push-pull LLC resonant converter 106 shown in FIG. 10, a transformer Tr with four windings (Np1, Np2, Ns1, Ns2) is used, and the two resonant tanks couple to one of Port 2 and Port 3. In some embodiments, a Full-Bridge LLC resonant converter 106, as shown in FIG. 7B, may have a transformer Tr with three windings (Np, Ns1, Ns2), and two resonant tanks each coupled to one of Port 2 and Port 3. The resonant frequencies of the two resonant tanks may be the same or very close to each other.

For the three-port LLC converter 106, the Port that is acting as the source (i.e., transferring power to one or both other Ports) is defined as the input Port. The Port that receives power from the input Port and then delivers power to an output (i.e., produces the output power) is defined as the output Port(s). In some embodiments, one Port will be an input Port, and two Ports will be output Ports.

The switching components at the input Port act as the control switches. The switches at the other two output Ports act as synchronous rectifier switches (SR FET). The switching frequency of converter 106 is set to be about equal to the resonant frequency of converter 106.

When the ESS battery at Port 1 is acting as the input Port, the voltages Vdc2, Vdc3 at the output Ports (i.e., Ports 2 and 3) vary based on the ESS battery voltage. A controller 1910 may modulate the switches Q11 and Q12 at Port 1 as control switches and modulate the switches SR21, SR22, SR23, SR24, SR31, SR32 at the two output Ports (Port 2 and Port 3) as synchronous rectifiers. The bidirectional DC-DC regulator at Port 2 may regulate the delivered voltage from Port 1 such that the output voltage, V_load, from the DC-DC regulator can be controlled to output a desired value. Further, the bidirectional DC-AC inverter at Port 3 may regulate the delivered voltage from Port 1 such that the output AC voltage Vac can be controlled to output a desired value.

When the ESS battery at Port 1 is acting as an output Port (i.e., receiving power from either Port 2 or Port 3), controller 1910 may calculate the power that is available to charge the ESS battery based on the maximum power Pmax of the converter 106 and the power taken by the other output Port. Controller 1910 may also calculate a desired battery charging current as determined by equations (49) and (50). Controller 1910 may produce a reference voltage (Vdc2_ref, Vdc3_ref) to regulate the voltage level of the input Port (i.e., either Port 2 or Port 3) so that the battery charging current is about equal to the desired battery charging current determined previously. For example, when Vdc3 at Port 3 is acting as the input port (i.e., providing power to Port 1), controller 1910 will calculate the required battery charging current and produce a voltage reference, Vdc3_ref, so that the bidirectional DC-AC inverter at Port 3 (which operates in rectifier mode in this condition) generates a voltage input to the converter 106 which is equal to the reference voltage (i.e., Vdc3=Vdc3_ref).

Lastly, controller 1910 may measure the terminal voltage and power at Port 1, Port 2 and Port 3, and calculate the battery charging current and set the reference voltage for the bidirectional DC-DC regulator (Vdc2_ref) or the bidirectional DC-AC inverter (Vdc3_ref). In practical implementation, the voltage and current through each Port are measured, and the power of each Port is calculated by multiplying the measured voltage and current. Controller 1910 may also generate gate drive signals to the three-port LLC converter 106.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A three port LLC resonant converter for transferring power between three ports each acting as an input port or a load port, the converter comprising:
a first port coupled in series to at least one winding on a primary side of a transformer and coupled to a switching network containing at least two switches Q1 and Q2 which control a current flow to the at least one primary side winding of the transformer;
a second port coupled to at least one first winding on a secondary side of the transformer, and having a first resonant tank and a first rectifier between the second port and the at least one first winding on the secondary side of the transformer;
a third port coupled to at least one second winding on the secondary side of the transformer, and having a second resonant tank and a second rectifier between the third port and the at least one second winding on the secondary side;
wherein one of the first, second and third ports is the input port which acts as a power source for the three-port LLC resonant converter, and at least one of the first, second and third ports is the load port which receives the power from the power source and transmits the power to a load.

2. The converter of claim 1, wherein the switches Q1 and Q2 of the first port, at least two switches in the first rectifier of the second port, and at least two switches of the second rectifier of the third port are active switches which are configured for bi-directional operation.

3. The converter of claim 1, wherein the first port is coupled to an energy storage device which can act as the load when the first port is the load port, and as the power source when the first port is the input port.

4. The converter of claim 3, wherein when the energy storage device acts as the power source, the first port is configured as an input port and the second and third ports are configured as output ports, such that voltages at the second and third ports vary with a voltage at the first port.

5. The converter of claim 3, wherein when the energy storage device acts as the load, the first port is configured as a load port and one of the second and third ports is configured as the input port, and a battery charging current is controlled by the voltage at the input port.

6. The converter of claim 3, wherein the first rectifier at the second port is implemented as a full bridge rectifier, and the second rectifier at the third port is implemented as a voltage doubler.

7. The converter of claim 2, wherein the second port is connected to a bidirectional DC-DC regulator and the third port is connected to a bidirectional DC-AC inverter.

8. The converter of claim 1, wherein switches of an input port operate as control switches and switches of an output port operate as synchronous rectifiers.

9. The converter of claim 1, wherein a resonant frequency of the first resonant tank and a resonant frequency of the second resonant tank are about equal.

10. The converter of claim 1, wherein the transformer provides galvanic isolation between the first, second, and third ports to maintain a distinct ground reference at each of the ports.

11. The converter of claim 1, wherein the first port comprises a battery pack operating at approximately 3 V, the second port operates between 20 V and 24 V, and the third port operates between 330 V and 360 V.

12. The converter of claim 1, further comprising a multi-phase transformer topology including first and second transformers whose primary windings are connected in parallel at the first port and whose secondary and tertiary windings are connected in series at the second and third ports, respectively, wherein a first primary winding is driven by the switches Q1 and Q2 in interleaved operation, and a second primary winding is driven by switches Q3 and Q4 in interleaved operation.

13. A three port power conversion system for transferring power between three ports each acting as either a load or a source, the system comprising:
a first port of the power conversion system coupled to a battery;
a second port of the power conversion system coupled to a bi-directional DC-DC regulator;
a third port of the power conversion system coupled to a bi-directional DC-AC inverter;
a first, second, and third switching network within the power conversion system coupled to the first, second, and third port, respectively, and one of the first, second, and third ports is configured as an input port which feeds an input power into the conversion system;
at least one of the first, second and third ports is configured as an output port which receives the power from the input port and transfers the power to at least one of the battery, the bi-directional DC-DC regulator and the bi-directional DC-AC inverter;
a controller coupled to the first, second and third switching networks, and configured for:
sensing a voltage and a power level across each of the first, second, and third ports; and
generating, based on the sensed voltage and power level, a first, second and third gate drive signal for the first, second and third switching networks, respectively, which control the power flowing between the input port and the at least one output port.

14. The system of claim 13, further comprising a transformer coupled between the first, second and third switching networks to electrically isolate the first, second and third ports.

15. The system of claim 13, wherein when the first port is configured as an input port, a voltage supplied to the third port is controlled by the bi-directional DC-AC inverter, and a voltage supplied to the second port is controlled by the bi-directional DC-DC regulator.

16. The system of claim 13, wherein the controller is configured to calculate a set battery charging current based on a maximum converter power and a measured power at the third port, and the generating of the gate drive signal of the switching network of an input port is based on matching an actual battery charging current to the set battery charging current.

17. The system of claim 16, wherein the controller is configured to supply a voltage to the first port given the set battery charging current based on the parasitic impedance of the power conversion system.

18. The system of claim 13, wherein the controller is configured to set a switching frequency of the power conversion system to be substantially equal to a resonant frequency of a resonant components of the power conversion system.

19. The system of claim 13, wherein the controller is configured to turn on one or more of the first, second, and third switching networks under a zero-voltage switching condition.

20. The system of claim 13, wherein the controller is further configured for adjusting the switching frequency based on the resonant frequency using feedback from the second port, and maintaining a voltage at the third port substantially constant within a predefined tolerance to regulate a voltage at the second port with cross-regulation.
